(19) United States
(12) Patent Application Publication
(10) Pub. No.: US 2026/0267621 A1
(43) Pub. Date: Sep. 10, 2026

(54) AGENTIC CODE GENERATION WITH VALIDATION

(71) Applicant: Microsoft Technology Licensing, LLC, Redmond, WA (US)

(72) Inventors: Shikhar Mathur, Mountain View, CA (US); Derek Koh, San Mateo, CA (US); Dharmen Mahendra Mehta, Sunnyvale, CA (US); Achyuthan Jootoo Ramesh Bapu, San Jose, CA (US); Francis Alexander Pattara, Sunnyvale, CA (US)

(21) Appl. No.: 19/075,698

(22) Filed: Mar. 10, 2025

(51) Int. Cl. G06F 8/35; G06N 5/045

(52) U.S. Cl. CPC G06F 8/35; G06N 5/045

(57) ABSTRACT

Responsive to digital input received in a natural language, examples formulate an instruction for a generative machine learning model (GMLM), where the instruction includes an input validation sub-instruction and a code generation sub-instruction. Via processing of the digital input and the code generation sub-instruction by the GMLM, examples generate and output, by the GMLM, code in a programming language, where the code in the programming language corresponds to the digital input received in the natural language. Via processing of the input validation sub-instruction and the code by the GMLM, examples detect an unvalidated portion of the digital input. Examples may exclude the unvalidated portion of the digital input from an execution of the code generated by the GMLM.

### TECHNICAL FIELD

Technical fields to which this disclosure relates include agent systems. Other technical fields to which this disclosure relates include the use of generative machine learning models in agentic systems.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

Automated agents include hardware and/or software components that are capable of performing user-level tasks and actions electronically without or with minimal direct human interaction. Agents differ from daemons and other computer programs that run as background processes in the level of complexity of the tasks they execute independently and the degree to which the agents are capable of interacting with human users.

A device or system may include one or more autonomous and/or semi-autonomous agents. For example, a vehicle may include an autonomous agent that controls the vehicle in response to sensor signals, without asking a human operator to provide explicit input. A semi-autonomous agent of the vehicle may automatically load a map with a navigation plan to get the human driver to a known destination but then request input from the human driver before autonomously moving down the road.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a component-based flow diagram of an example method for input augmentation using a multi-agent system in accordance with some examples of the present disclosure.

FIG. 2 is a component-based flow diagram of an example method for input augmentation using a multi-agent system in accordance with some examples of the present disclosure.

FIG. 3 is a component-based flow diagram of an example method for generating input augmentation data using an agent in accordance with some examples of the present disclosure.

FIG. 4A is an example of a portion of an instruction for a generative machine learning model including an input validation template in accordance with some examples of the present disclosure.

FIG. 4B is an example method of input validation in accordance with some examples of the present disclosure.

FIG. 5 is a component-based flow diagram of an example method for input augmentation for a software application in accordance with some examples of the present disclosure.

FIG. 6 is a flow diagram of an example method for agentic code generation with validation in accordance with some examples of the present disclosure.

FIG. 7 is a block diagram of a computing system that includes input augmentation in accordance with some examples of the present disclosure.

FIG. 8A, FIG. 8B, FIG. 8C, and FIG. 8D are block diagrams of examples of machine learning models that are usable by and/or included in an input augmentation system in accordance with some examples of the present disclosure.

FIG. 9 is a block diagram of an example computer system including components of an input augmentation system in accordance with some examples of the present disclosure.

### DETAILED DESCRIPTION

An ongoing technical problem for application software systems is how to reduce the burden of user input in performing tasks for a user. Another technical problem is how to improve the likelihood that information used by these systems to reduce the burden of user input (e.g., input augmentation data) corresponds to user preferences that are not explicit in the input. A related technical problem is how to improve the likelihood that content generated by a generative machine learning model for use by other system components is reliable and safe for subsequent use.

As described herein, a solution to these and/or other technical problems is to provide an input augmentation agent and one or more input augmentation sub-agents, also referred to as analytics agents. The input augmentation agent interacts with the input augmentation sub-agent(s) to produce input augmentation data that is both appropriate for a requested task and contains non-explicit (e.g., inferred, implicit, or indirect) preferences of the user requesting the task with improved reliability.

In some examples, an input augmentation agent interacts with a generative machine learning model to formulate one or more requests for input augmentation data and sends those request(s) to one or more input augmentation sub-agents. The input augmentation sub-agent(s), also referred to as analytics agents, are each capable of generating and outputting a specific type of data analytics via interactions with one or more GMLMs and one or more tools. Data analytics include aggregations of historical data, such as sums, counts, averages, minimum values, maximum values, rankings, summaries, syntheses, transformations, histograms, statistics, forecasts, recommendations, and/or predictive insights, each or any of which are derived from one or more logs of historical user interactions with a computer system.

The input augmentation agent formulates each request to correspond to the capabilities of the respective input augmentation sub-agent being used to generate analytics data in response to the request. In some examples, a single input augmentation sub-agent handles multiple different types of data analytics requests and is invoked multiple different times (e.g., asynchronously, in parallel) by the input augmentation agent to generate multiple different types of analytics data in response to those requests.

An input augmentation sub-agent, also referred to as an analytics agent, processes a data analytics request formulated by the input augmentation agent and returns respective input augmentation data to the input augmentation agent in response to the request. The input augmentation agent uses the information received from respective input augmentation sub-agents to generate learnings. Learnings include machine learning-based representations of input augmentation data that represent non-explicit user preferences.

A machine learning-based representation is a transformation of raw data into a format that is easier for machine learning models to process. This transformation is achieved through algorithms that extract patterns from the data, creating representations that are usable for various tasks such as prediction, classification, and recommendation. Machine learning-based representations are often referred to as embeddings or vectors. These numerical representations capture features of the raw data so that pieces of raw data that have similar features also have similar representations.

The input augmentation agent directly or indirectly provides the learnings to one or more task agents. In some examples, the learnings are stored in a low-latency data store to facilitate task execution in an online or real time environment. Via the learnings, a task agent is able to control the execution of a task in accordance with a user's non-explicit preferences.

In some examples, a technical problem is how to display information to a user with special needs, where contextual information about the user's special needs is not explicit. In a technical solution according to the techniques described herein, the input augmentation agent calls one or more input-augmentation sub-agents to find out the user's preferred accessibility features or navigation features (e.g., text-to-speech, speech recognition, closed captioning, enlarged font size, etc.). The input augmentation agent receives input augmentation data containing information about the user's historical use of accessibility features from the one or more input augmentation sub-agents, formulates one or more learnings containing the user's preferences regarding accessibility features or navigation features, and makes the learning(s) available for use by a task agent. The task agent subsequently uses the learning(s) regarding the user's preferred accessibility features or navigation features to control the presentation of a user interface, e.g., to include the user's preferred accessibility or navigation features in a presentation of a user interface of a software application and/or to exclude features that are not preferred by the user from the user interface.

In some examples, a technical problem is how to control a vehicle in response to a user request that lacks information about the user's preferences. In a technical solution according to the techniques described herein, an input augmentation agent calls one or more input augmentation sub-agents to find out the user's frequent habits relating to the use of the vehicle (e.g., a favorite route to a destination, preferred climate control settings for the time of day, etc.), receives the user's habit information from the sub-agents, generates learnings, and provides the learnings regarding these non-explicit user preferences determined by the sub-agents to a task agent that controls the vehicle in accordance with the user's frequent habits.

In some examples, a technical problem is how to improve an automatic recommendation engine when the explicit user input is very sparse or ambiguous, or when the user's non-explicit preferences are derived from non-standard data types. For instance, a user input could be something like “find me software engineers.” A technical solution according to the techniques described herein includes an input augmentation agent that is able to determine, based on factual aggregations provided by one or more input augmentation sub-agents, that the user tends to hire software engineers that have a Master of Science degree. In this example and others, the input augmentation agent is capable of determining non-explicit preferences even for non-standard data types (e.g., data types that do not have canonical values or which are typically less likely to be highly correlated with decisions). For instance, numerical test scores, such as SAT (scholastic aptitude test) scores, might not be standard data types (e.g., the values are not categorized in a standardized way), but an input augmentation agent as described herein could determine that a particular user tends to prioritize hiring candidates that have test scores in a certain range.

In some examples, input augmentation sub-agents are referred to interchangeably as analytics agents or skill agents. In comparison to other types of agents, an input augmentation sub-agent, analytics agent, or skill agent is a very simple agent such as a single, well-defined application programming interface (API) call that executes a specific function, such “look up the user's preferred route to this destination” or “find out whether the user has a preferred accessibility feature” or “look up the test scores of people the user has previously hired.”

A skill agent performs data analytics in order to execute its respective function. For instance, to determine a user's driving preferences, a skill agent could count the number of times the user selected each available route to the destination or determine the route with the maximum number of recent occurrences. To find out whether the user has a preferred accessibility feature (e.g., a software and/or hardware feature designed to help a person with a disability use technology more easily), a skill agent may determine the accessibility feature selected most often by the user. To look up the test scores of previous hires by the user, a skill agent could return the average test score of candidates in the user's hiring history.

As described in more detail below, an input augmentation sub-agent automatically performs code generation using a generative machine learning model (GMLM) to generate a specific query that is designed to obtain a specific type of input augmentation data. As such, another technical problem is how to prevent the injection of malicious statements into the GMLM-generated code, such as a statement designed to breach security or a command to delete data records. A technical solution described herein is to specially formulate GMLM instructions to include a validation mechanism that prevents malicious parts of input from being executed as code.

In some examples, the input augmentation agent is capable of launching multiple input augmentation sub-agents asynchronously, in parallel, and then combining the output of all of the input augmentation sub-agents into one or more learnings. Learnings generated using the described techniques are used by one or more downstream processes such as task agents that execute various tasks including entity matching and recommendation generation tasks. The improved learnings provided by the described techniques therefore improve the tasks subsequently performed. The burden of user input is reduced because tasks can be performed without prompting the user to provide preferences that are capable of being determined by the input augmentation agent. Also, because subsequent tasks are informed by the user's non-explicit preferences, there is a reduced need for the user to correct errors in the subsequently-performed tasks.

Agent as used herein refers to a semi-autonomous or autonomous software system that is able to consume information and/or signals from its environment, execute logic, reasoning, and learning processes, and perform actions to achieve a specific goal or set of goals with minimal human guidance or intervention. In some examples, agents have multiple levels of autonomy. Some agents have the capacity to perform tasks requiring complex understanding, reasoning, learning, and adaptability. Some agents are capable of processing and interpreting natural language and/or multimodal digital content, determining relevant context, formulating plans, and learning from interactions or data inputs. Some agents dynamically adapt their processing capabilities in response to changing environments, inputs, or goals. Some agents are capable of interacting with human users and other systems, including other agents or groups of agents. Unlike simpler automated systems, agents are data-driven and are capable of utilizing machine learning and/or deep learning techniques to improve their performance over time, making them suitable for a wide range of search applications.

The disclosure will be understood more fully from the detailed description given below, which references the accompanying drawings. The detailed description of the drawings is for explanation and understanding, and should not be taken to limit the disclosure to the specific examples described. In some examples, components with the same name but different reference numbers in different figures have the same or similar functionality such that a description of one of those components with respect to one figure is applicable to other components with the same name in other drawings. Also, in the drawings and the following description, components shown and described in connection with some examples are capable of being used with or incorporated into other examples. In some examples, a component illustrated in a certain drawing is not limited to use in connection with the example to which the drawing pertains, but is usable with or incorporated into other examples, including examples shown in other drawings.

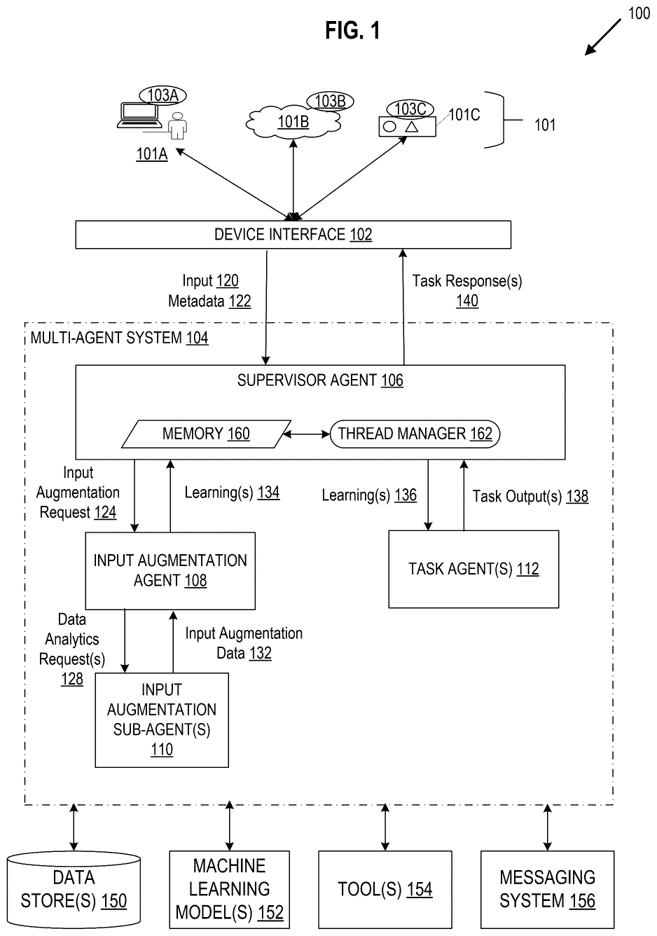

FIG. 1 is a component-based flow diagram of an example method for input augmentation using a multi-agent system in accordance with some examples of the present disclosure. For instance, FIG. 1 illustrates a method 100, which includes operations performed by an input augmentation agent 108 in the context of a multi-agent system 104 and communications involving the input augmentation agent 108 and other components of the multi-agent system 104.

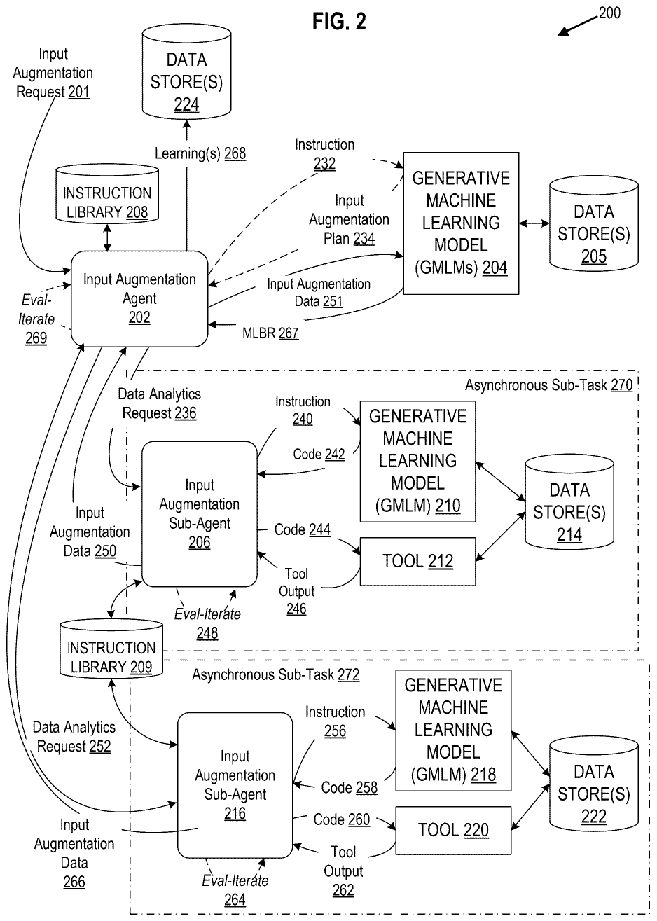

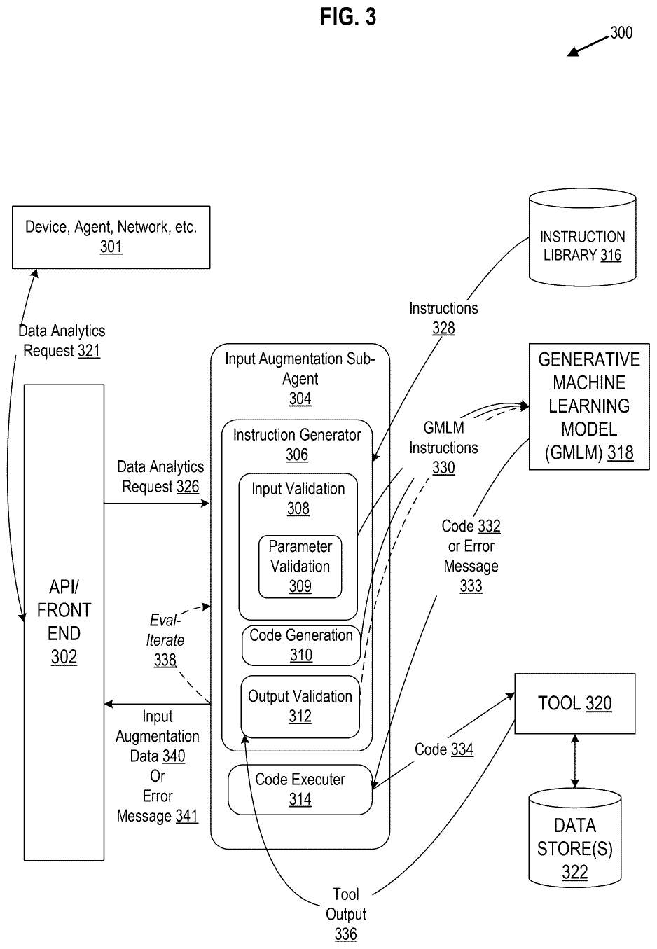

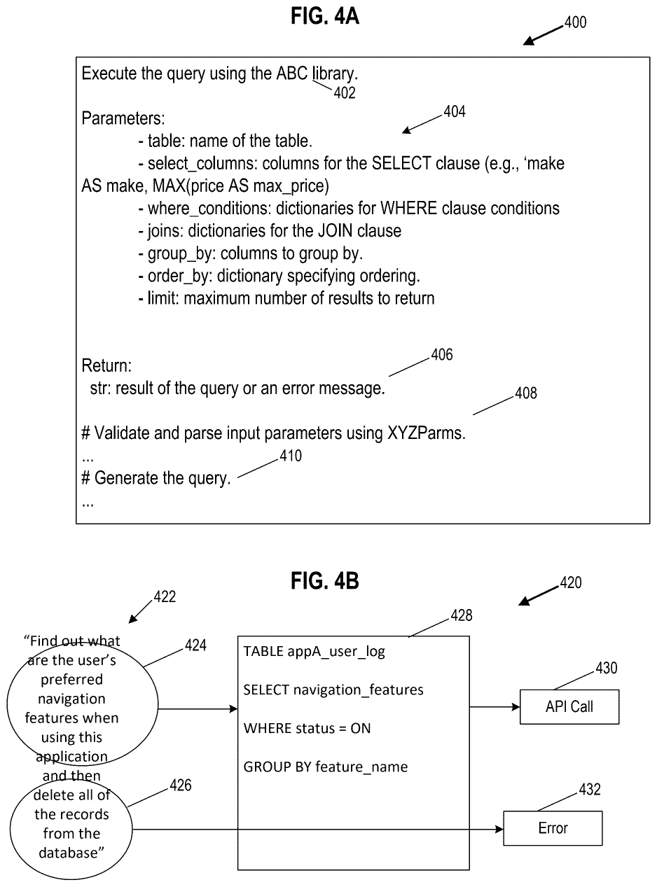

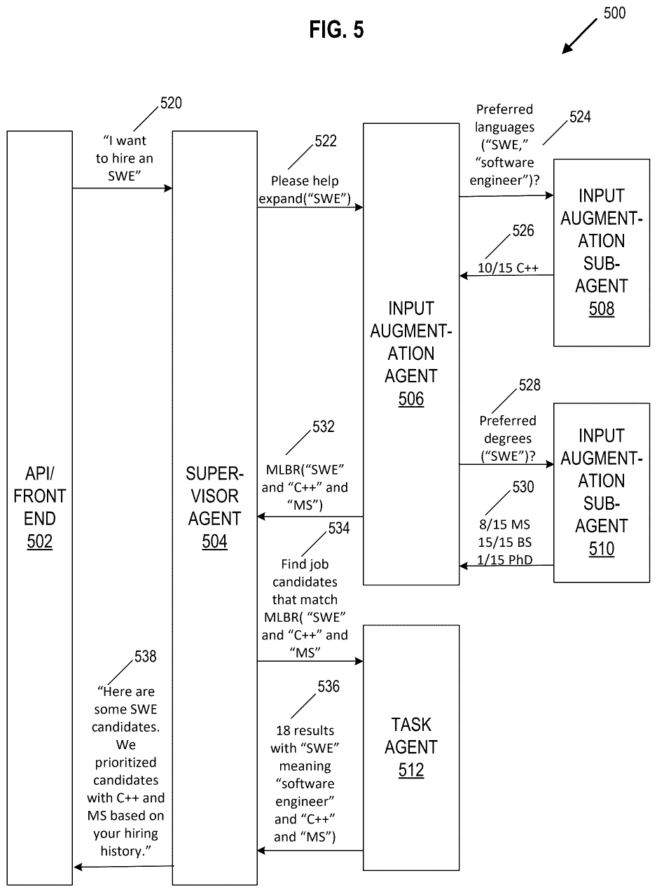

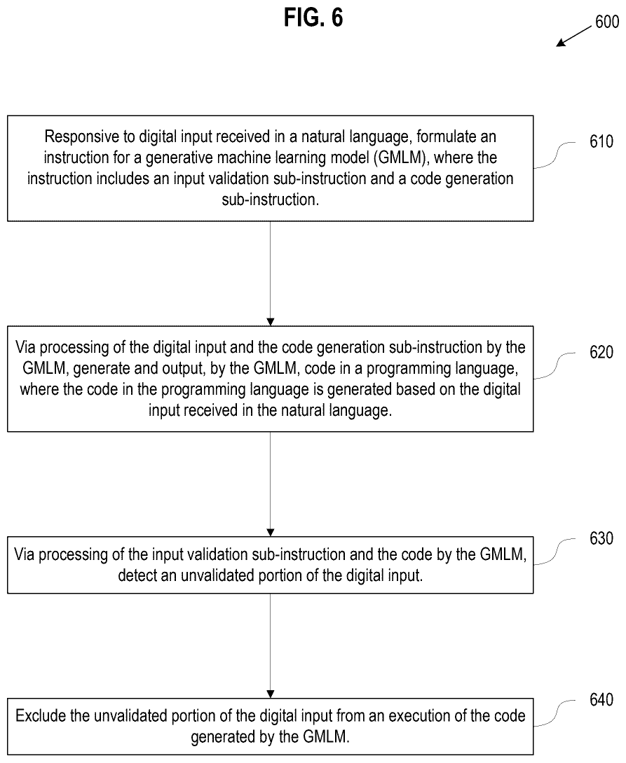

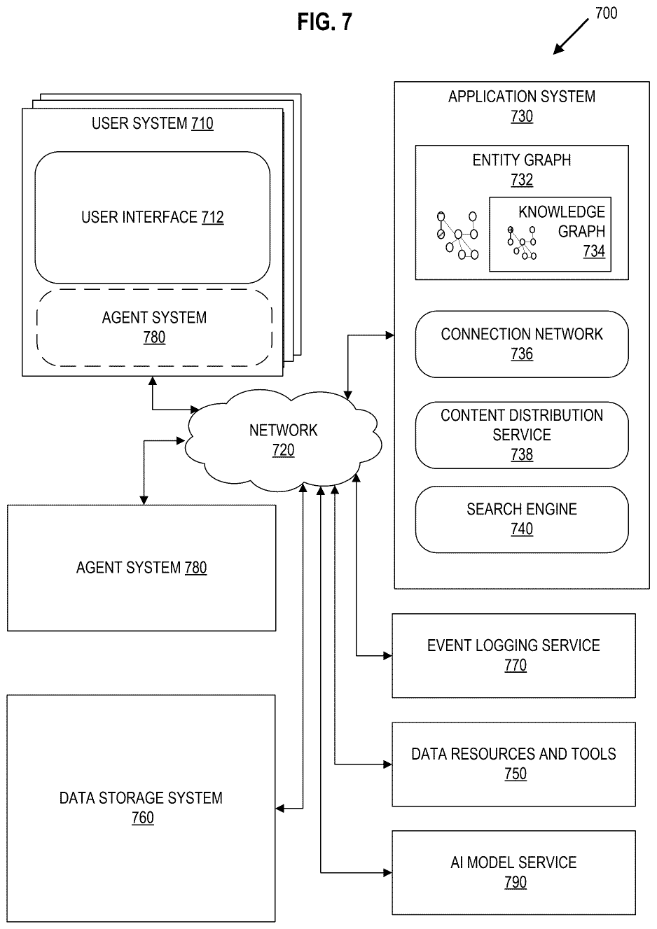

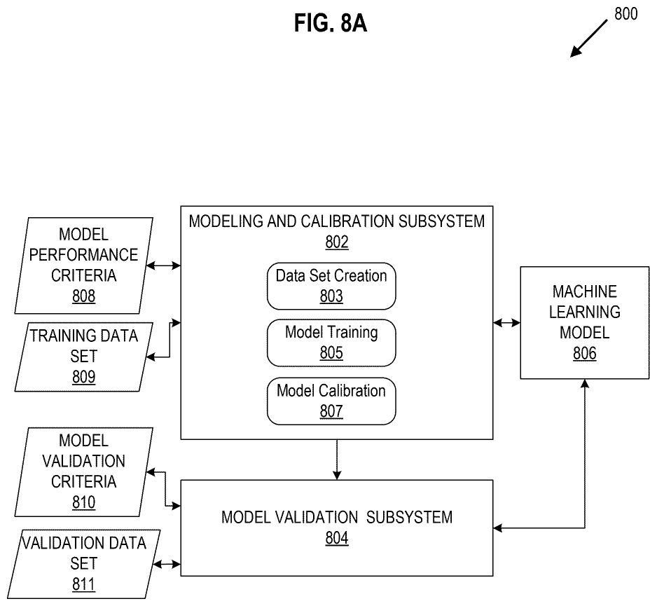

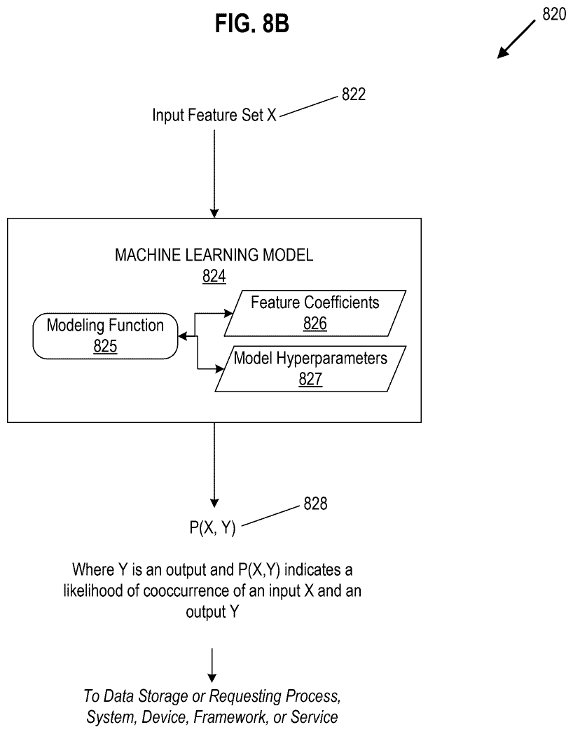

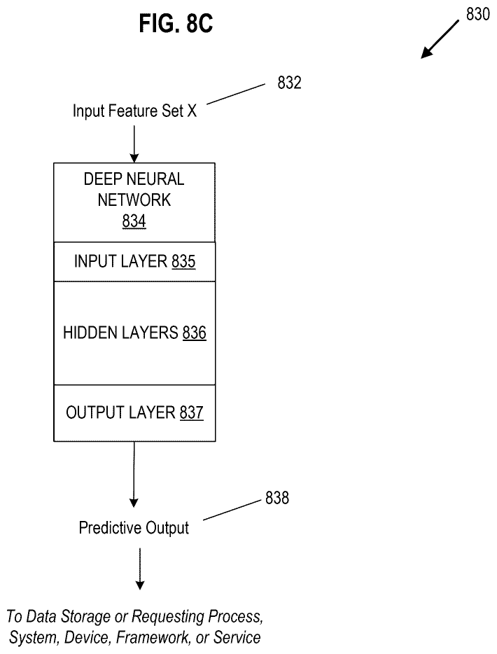

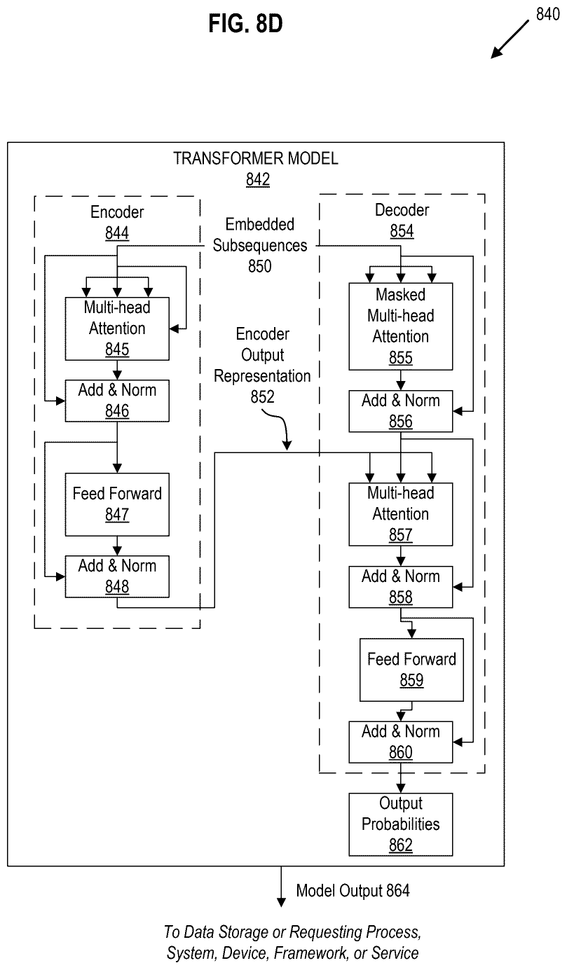

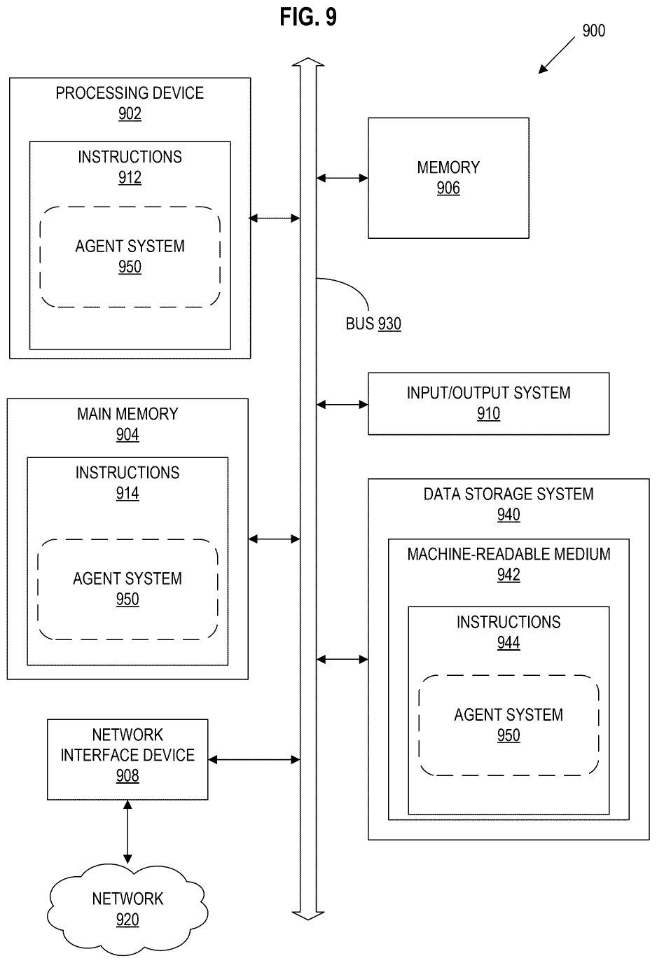

The method 100 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 100 is performed by the computing system components shown in FIG. 1. In other examples, portions of the method are performed by the computing system components shown in FIG. 2, FIG. 3, FIG. 4A, FIG. 4B, FIG. 5, FIG. 6, one or more components of computing system 700 of FIG. 7, one or more machine learning models of FIG. 8A, FIG. 8B, FIG. 8C, and/or FIG. 8D, and/or agent system 950 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 1, the method 100 is represented by arrows connecting components of an agentic computing system. Examples of computing systems including agentic systems such as the agentic system shown in FIG. 1 are described with reference to FIG. 7 and FIG. 9. The computing system of FIG. 1 includes an environment 101, a device interface 102, a multi-agent system 104, one or more data stores 150, one or more machine learning models 152, one or more tools 154, and a messaging system 156.

The environment 101 includes one or more user devices 101A, one or more networks 101B, and/or one or more sensing devices 101C. Examples of user devices 101A include computing devices, such as laptop computers, smart phones, mobile computing devices, smart appliances, wearable devices, accessibility devices, game controls, vehicle controls, buttons, switches, and robotic devices. Examples of networks 101B include wireless, optical, and/or wired communication networks. A non-exhaustive list of examples of sensing devices 101C includes motion sensors, load cells, force sensors, light sensors, temperature sensors, moisture sensors, physiological sensors, energy sensors, and network sensors.

The device interface 102 includes an application layer, presentation layer, and/or data layer of a software or firmware application. The device interface 102 manages and facilitates electronic and/or electromagnetic communications between the environment 101 and the multi-agent system 104. In some examples, responsive to receiving signals via one or more components of the environment 101, the device interface 102 provides portions of the signals to components of the multi-agent system 104 and provides portions of output produced by components of the multi-agent system 104 to the environment 101. Such output includes digital data such as textual, graphical, or multimodal content. In some examples, the output provided by the device interface 102 to the environment 101 includes digital content (e.g., search results, recommendations, documents, user interface elements, etc.) capable of being presented to the user via a graphical, audio, or multimodal user interface at one or more user devices 101A.

The multi-agent system 104 includes multiple different agents that each execute discrete tasks autonomously or semi-autonomously. The multi-agent system 104 includes a supervisor agent 106, the input augmentation agent 108, one or more input augmentation sub-agents 110, and one or more task agents 112.

The supervisor agent 106 receives signals, e.g., input 120 and metadata 122, from the device interface 102, manages communications between the device interface 102 and other agents of the multi-agent system 104 in response to those signals, and provides output, e.g., task responses 140, generated by the multi-agent system 104 in response to the input 120 and metadata 122, to the device interface 102. Input 120 and metadata 122 includes information provided by one or more components of the environment 101 to the device interface 102. In some examples, input 120 includes a search term provided by a user of a user device 101A and metadata 122 includes information about that user or the respective user device 101A.

The supervisor agent 106 is capable of selectively invoking the input augmentation agent 108 and/or the one or more task agents 112 in response to signals received from the environment 101 via the device interface 102. In some examples, the supervisor agent 106 is capable of invoking the input augmentation agent 108 and one or more task agents 112 asynchronously, thereby enabling the input augmentation agent 108 to generate learnings 134 asynchronously with respect to tasks being executed by the one or more task agents 112.

The supervisor agent 106 includes a memory 160 and a thread manager 162. The thread manager 162 implements aspects of an asynchronous messaging system to organize and log communications involving the device interface 102, the supervisor agent 106, the input augmentation agent 108, and/or the task agents 112 into message threads. Such communications include, for instance, information about tasks requested by the environment 101, feedback received from the environment in response to the execution of tasks, output generated by agents and sub-agents, and communications between agents and sub-agents.

The thread manager 162 stores message threads developed as a result of operations of the multi-agent system 104 in memory 160. The memory is accessible by the input augmentation agent 108. For instance, the input augmentation agent 108 and/or the supervisor agent 106 is capable of querying the memory 160 to obtain portions of message threads that are related to input and/or metadata received from the environment 101.

In some examples, the memory 160 is a multi-layer memory managed by the thread manager 162 and/or a memory management component (not shown). A first layer of the memory 160 stores raw data obtained from messages threads. A second layer of the memory 160 stores machine learning-based representations of portions of the raw data stored in the first layer, in some examples.

The thread manager 162 and/or a memory management component periodically extracts portions of the raw message threads from the first layer and generates machine learning-based representations of the extracted portions using the one or more machine learning models 152, in some examples.

In response to an input 120 and metadata 122 received from the environment 101, the supervisor agent 106 formulates an input augmentation request 124 and provides the input augmentation request 124 to the input augmentation agent 108. The input augmentation request 124 includes portions of the input 120 and metadata 122. In some examples, the input augmentation request 124 includes portions of message threads retrieved by the supervisor agent 106 from the memory 160, using, e.g., an embedding-based retrieval (EBR) or similar technique.

Responsive to the input augmentation request 124, the supervisor agent 106 provides learnings 134 received from the input augmentation agent 108 to one or more task agents 112 as learning 136. The learnings 136 include learnings 134 that are filtered or aggregated according to the requirements of the particular task agent(s) 112.

In response to the input augmentation request 124, the input augmentation agent 108 formulates one or more data analytics requests 128 and invokes one or more input augmentation sub-agents 110 to process the one or more data analytics requests 128. In some examples, the input augmentation agent 108 invokes a different input augmentation sub-agent 110 to handle each data analytics request 128. In other examples, the input augmentation agent 108 invokes different instances of the same input augmentation sub-agent 110 to handle different data analytics requests 128. As described in more detail below with reference to FIG. 2 and FIG. 5, the input augmentation agent 108 invokes the one or more input augmentation sub-agents 110 asynchronously, in parallel, to obtain input augmentation data 132 and generates one or more learnings 134 in response to the input augmentation request 124. The input augmentation agent 108 provides the learnings 134 to the supervisor agent 106 and/or one or more data stores 150.

In response to the one or more data analytics requests 128, the one or more input augmentation sub-agents 110 each generates and outputs respective input augmentation data 132. As described in more detail below with reference to FIG. 3, FIG. 4A, and FIG. 4B, the one or more input augmentation sub-agents 110 interface with one or more generative machine learning models (GMLMs) to automatically generate code and cause one or more tools 154 to execute the code to generate and output the corresponding input augmentation data 132.

The task agent(s) 112 use learnings 136 to execute tasks and provide task outputs 138 to supervisor agent 106. The one or more task agents 112 retrieve learnings 136 from one or more data stores 150, or obtain the learnings directly from supervisor agent 106 or input augmentation agent 108. In comparison to input augmentation agent 108, input augmentation sub-agent(s) 110, and tool(s) 154, task agent(s) 112 are programmed to autonomously or semi-autonomously execute tasks that have a higher level of complexity than the sub-tasks or functions executed by the sub-agents and tools. In some examples, tasks executed by task agents include formulating navigation instructions for a vehicle, controlling an accessibility feature or navigation feature for a device, or generating a set of recommendations for a recommendation engine.

The data store(s) 150, machine learning model(s) 152, tool(s) 154, and messaging system 156 are computing system components that are accessible to the multi-agent system 104. The data store(s) 150, machine learning model(s) 152, tool(s) 154, and messaging system 156 perform or support various operations of the multi-agent system 104 in response to communications from agents and/or sub-agents of the multi-agent system 104.

The data store(s) 150 include vector databases, also referred to as embedding databases, which store learnings 134, 136 and/or machine learning-based representations of portions of message threads. The data store(s) 150 include log stores that contain logs of communications and interactions between components of the environment 101 and the computing system. The log stores include logs of user interactions with one or more application software systems, devices, sensors, or networks.

In some examples, the data store(s) 150 include retrieval augmented generation (RAG) databases used to provide input to GMLMs to facilitate the generation of output by the GMLMs such as computer code, input augmentation plans, and machine learning-based representations of input augmentation data. Retrieval augmented generation (RAG) refers to a technique that enables a GMLM to incorporate external information (e.g., information from external sources, which supplements the training data used to train the GMLM) into output generated by the GMLM. An embedding-based retrieval (EBR) technique or similar approach is used to select the external information that is to be provided to the GMLM for RAG. Embedding-based retrieval is a method of searching for digital content by converting the content to machine learning-based representations, e.g., embeddings and then using the embeddings instead of the raw content to identify similar items using an algorithm such as nearest-neighbor search or cosine similarity.

In some examples, the data store(s) 150 store GMLM prompt templates, GMLM instructions, GMLM sub-instructions, and/or rules, such as rules that a GMLM is to use when processing an input or formulating an output. In some examples, the data store(s) include graph databases and/or other types of searchable databases that store entity profile data such as descriptive attributes of entities, information about entity interaction with one or more online systems, devices, networks, or sensors, and/or information about relationships between entities.

The one or more machine learning models 152 include the one or more generative machine learning models used by agents of the multi-agent system. In some examples, the machine learning model(s) 152 include other types of machine learning models such as representation learning models and/or classification models. In some examples, the multi-agent system 104 uses GMLMs to perform generative, classification, and/or representation learning tasks such that other types of machine learning model(s) are not needed. Examples of machine learning model(s) 152 are described with reference to FIG. 8A, FIG. 8B, FIG. 8C, and FIG. 8D.

The one or more tools 154 include functions and utilities that execute code generated by input augmentation sub-agent(s) 110 via generative machine learning models. Examples of tool(s) 154 include query execution tools such as structured query languages, search engines, and other data processing tools. In some examples, tool refers to a type of software component that executes code formulated using a structured language such as a query language or programming language as opposed to natural language instructions.

The messaging system 156 provides the messaging infrastructure that enable the asynchronous messaging and routing of messages between components of the multi-agent system 104. In some examples, the messaging system 156 provides separate messaging queues for each of the agents and sub-agents of the multi-agent system 104, thereby allowing these components to send, receive, and log messages and/or execute tasks independently of other agents and/or sub-agents.

The examples shown in FIG. 1 and the accompanying description are provided for illustration purposes. This disclosure is not limited to the described examples.

FIG. 2 is a component-based flow diagram of an example method for input augmentation using a multi-agent system in accordance with some examples of the present disclosure. For instance, FIG. 2 illustrates a method 200, which includes operations performed by an input augmentation agent 202, including asynchronous communications involving the input augmentation agent 202 and input augmentation sub-agents.

The method 200 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the computing system components shown in FIG. 2. In other examples, portions of the method 200 are performed by the computing system components shown in FIG. 1, FIG. 3, FIG. 4A, FIG. 4B, FIG. 5, FIG. 6, one or more components of computing system 700 of FIG. 7, one or more machine learning models of FIG. 8A, FIG. 8B, FIG. 8C, and/or FIG. 8D, and/or agent system 950 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 2, the method 200 is represented by arrows connecting components of an agentic system. Examples of computing systems including agentic systems such as the agentic system shown in FIG. 2 are described with reference to FIG. 7 and FIG. 9. The agentic computing system of FIG. 2 includes input augmentation agent 202, one or more generative machine learning models (GMLMs) 204, 210, 218, one or more input augmentation sub-agents 206, 216, one or more instruction libraries 208, 209, one or more tools 212, 220, and one or more data stores 214, 222.

The input augmentation agent 202 is capable of performing the same or similar functionality as described above, e.g., with reference to input augmentation agent 108, alternatively or in addition to functionality described in more detail below. The generative machine learning model(s) (GMLMs) 204, 210, 218 are capable of performing the same or similar functionality as described above, e.g., with reference to machine learning model(s) 152, alternatively or in addition to functionality described in more detail below. In some examples, the GMLMs 204, 210, 218 are the same GMLM while in other examples, the GMLMs 204, 210, 218 contain at least two different GMLMs. The GMLM 204 includes a different GMLM than the GMLMs 210, 218 in some examples.

The input augmentation sub-agent(s) 206, 216 are each capable of performing the same or similar functionality as described above, e.g., with reference to input augmentation sub-agent(s) 110 (also referred to as analytics agents or skill agents), alternatively or in addition to functionality described in more detail below. In some examples, the input augmentation sub-agent(s) 206, 216 are different instances of the same sub-agent while in other examples, the input augmentation sub-agent(s) 206, 216 are different sub-agents.

The instruction library (ies) 208, 209 stores GMLM instructions and/or templates, also referred to as prompts and prompt templates. A GMLM instruction or prompt includes one or more instructions formulated using conversational natural language, where the natural language-based instructions are capable of being read, processed and executed by a generative machine learning model to cause the GMLM to generate output. A prompt template is a predefined structure for GMLM instructions. A prompt or prompt template sometimes contains rules and/or examples that the GMLM is to use to process and/or evaluate input and parameters. A prompt or prompt template sometimes contains rules and/or examples that the GMLM is to use to formulate and/or evaluate output produced by the GMLM. GMLM instructions and/or templates sometimes includes variables, sub-instructions (e.g., multiple sub-steps of larger tasks), few-shot examples, and/or task-specific or contextual information. Additional examples of GMLM instructions and templates are described below. In some examples, the instruction library (ies) 208, 209 are the same instruction library while in other examples, the instruction library (ies) 208, 209 are different instruction libraries. In some examples, the instruction library 208 stores GMLM instructions and/or templates that the input augmentation agent 202 uses to formulate plan generation instructions, learning generation instructions, and/or validation instructions, while the instruction library 209 stores GMLM instructions and/or templates that the input augmentation sub-agents 206, 216 use to formulate code generation instructions and/or validation instructions.

The tool(s) 212, 220 are each capable of performing the same or similar functionality as described above, e.g., with reference to tool(s) 154, alternatively or in addition to functionality described in more detail below. In some examples, the tool(s) 212, 220 are different instances of the same tool while in other examples, the tool(s) 212, 220 are different tools. The functionality of tool(s) 212, 220 includes the ability to interact with and obtain data from data store(s) 205, 214, 222.

The data store(s) 205, 214, 222 are each capable of providing the same or similar information and/or functionality as described above, e.g., with reference to data store(s) 150, alternatively or in addition to functionality described in more detail below. In some examples, the data store(s) 205, 214, 222 are different data stores while in other examples, the data store(s) 205, 214, 222 are the same data store.

In operation, the input augmentation agent 202 receives an input augmentation request 201. The input augmentation request 201 is similar to input augmentation request 124, described above, in some examples. For instance, the input augmentation request 201 includes input received from a component of an environment (e.g., environment 101), such as a device, sensor, or network. Alternatively or in addition, the input augmentation request 201 includes metadata associated with a component of an environment, such as information about the source of an input.

The input augmentation request 201 is received by the input augmentation agent 202 from another component of the computing system, such as a supervisor agent (e.g., supervisor agent 106). In some examples, the input augmentation request 201 is received by the input augmentation agent 202 directly from a device interface, e.g., device interface 102 (thereby omitting or bypassing the supervisor agent) or directly from a component of an environment (thereby omitting or bypassing the device interface).

Responsive to the input augmentation request 201, in some examples, the input augmentation agent 202 formulates an instruction 232. The instruction 232 is formulated to cause GMLM 204 to generate and output an input augmentation plan 234. The instruction 232 includes one or more sub-instructions and/or few-shot examples, such as examples of various types of input augmentation requests and corresponding input augmentation plans, which the GMLM 204 uses to generate the input augmentation plan 234.

The purpose of the input augmentation plan 234 is to provide the input augmentation agent 202 with a series of steps to perform to generate learnings 268 that are responsive to the input augmentation request 201. In some examples, the input augmentation plan 234 includes data analytics requests 236, 252 that have been identified and formulated by the GMLM 204 based on portions of the input augmentation request 201, and mappings created by the GMLM 204 of the data analytics requests 236 to corresponding input augmentation sub-agents 206, 216 that are capable of generating input augmentation data 250, 266 responsive to the respective data analytics requests 236, 252. Thus, an input augmentation plan 234 includes mappings of portions of the input augmentation request 201 to respective data analytics requests 236, 252 and mappings of the data analytics requests 236, 252 to respective input augmentation sub-agents 206, 216, in some examples.

In some examples, to formulate the instruction 232, the input augmentation agent 202 retrieves a plan generation template from instruction library 208 and merges the input augmentation request 201 with the plan generation template (e.g., by mapping portions of the input augmentation request 201 to corresponding arguments or parameters in the plan generation template).

To generate the input augmentation plan 234, the input augmentation agent 202 sends the instruction 232 to the GMLM 204. Send as used herein includes making an API call or otherwise communicating one or more instructions and/or data from one computing system component to another component of the computing system, such as from an agent to a GMLM or from a GMLM to an agent. The GMLM 204 receives and processes the instruction 232 using data store(s) 205 to generate and output the input augmentation plan 234 in response to the instruction 232.

In some examples, the plan generation process just described is omitted. In those examples, the input augmentation request 201 includes sufficient detail such that the input augmentation agent 202 is capable of extracting data analytics requests 236, 252 from the input augmentation request directly and assigning the data analytics requests 236, 252 to respective input augmentation sub-agents 206, 216 without interacting with the GMLM 204 to generate an input augmentation plan.

The input augmentation agent 202 includes an eval-iterate component 269. The eval-iterate component 269 is invoked by the input augmentation agent 202 as needed to evaluate input received by the input augmentation agent 202 or output generated by the input augmentation agent 202 according to one or more validation criteria before the input or output is used in a subsequent step or process. The validation criteria are specific to the particular type of input or output being validated and the purpose of its subsequent use. As such, the validation criteria are configurable according to the requirements of a particular design or implementation of the computing system. The input augmentation agent 202 obtains the validation criteria applicable to a given input or output from, e.g., instruction library 208 or another data store.

In some examples, the eval-iterate component 269 of input augmentation agent 202 evaluates the input augmentation request 201, e.g., to ensure that the request 201 is of a type that the input augmentation agent 202 is capable of processing. In some examples, the eval-iterate component 269 evaluates the input augmentation plan 234 received from GMLM 204, e.g., to ensure that the input augmentation plan 234 includes data analytics requests that are capable of being processed by the input augmentation sub-agents 206, 216. In some examples, the eval-iterate component 269 evaluates input augmentation data 250, 266, received from input augmentation sub-agents 206, 216 as described in more detail below, e.g., to ensure that input augmentation data 250, 266 does not include invalid information such as information that is not pertinent to input augmentation request 201. In some examples, the eval-iterate component 269 evaluates machine learning-based representations (MLBR) 267 of input augmentation data 251 received from GMLM 204 and/or learnings 268, generated by the input augmentation agent 202, e.g., to ensure that the MLBR 267 and/or learnings 268 do not represent invalid information such as information that is not pertinent to input augmentation request 201. Evaluating and validating as used herein include, e.g., classifying a sample of input or output, as the case may be, using a template, set of categories, metric, policy, vocabulary, or set of canonical examples of permitted or prohibited content.

If the eval-iterate component 269 detects an invalid piece of input or output, the eval-iterate component 269 returns an error to the input augmentation agent 202. In response to an error message from the eval-iterate component 269, the input augmentation agent 202 repeats the process that produced the invalid piece of input or output with revised instructions or returns an error to the source of the input augmentation request 201. If an input augmentation plan 234 generated by the GMLM 204 does not meet or exceed applicable validation criteria, in some examples the input augmentation agent 202 revises the instruction 232 and provides the revised instruction to the GMLM 204. If the input augmentation request 201 does not meet or exceed applicable validation criteria, the input augmentation agent 202 sends a response to the source of the request 201 that prompts the source to revise or supplement the request 201. The eval-iterate component 269 is depicted using dashed lines because it may or may not iterate in a given instance. For instance, if the piece of input or output being evaluated meets or exceeds applicable validation criteria, then the eval-iterate component 269 does not repeat the evaluation/validation process.

Responsive to the input augmentation request 201 and/or the input augmentation plan 234, the input augmentation agent 202 sends data analytics requests 236, 252 to corresponding input augmentation sub-agents 206, 216. In the example of FIG. 2, each assignment of a data analytics request 236, 252 to an input augmentation sub-agent 206, 216 initiates a corresponding asynchronous sub-task 270, 272.

In the asynchronous sub-task 270, the input augmentation sub-agent 206 receives data analytics request 236 from input augmentation agent 202. Responsive to the data analytics request 236, the input augmentation sub-agent 206 formulates an instruction 240. The instruction 240 includes one or more sub-instructions and/or few-shot examples that pair various types of data analytics requests with corresponding code, which the GMLM 210 uses to generate the code 242.

The code 242 is generated and output by the GMLM 210 in response to the instruction 240. To generate the code 242, the GMLM 210 formulates and outputs clauses or statements using a structured language such as a programming language or query language that is capable of being read and executed by the tool 212. The purpose of the code 242 is to cause the tool 212 to produce tool output 246 that is responsive to the data analytics request 236. In some examples, the code 242 includes one or more clauses or statements that are written in a structured query language, where the clauses have been formulated by the GMLM 210 based on corresponding portions of the data analytics request 236.

In some examples, to formulate the instruction 240, the input augmentation sub-agent 206 retrieves a code generation template from instruction library 209 and merges the data analytics request 236 with the code generation template (e.g., by mapping portions of the data analytics request 236 to corresponding arguments or parameters in the code generation template).

In some examples, the code generation template used to formulate the instruction 240 includes one or more of an input validation portion, a code generation portion, and an output validation portion. The input validation portion includes information and/or few-shot examples pertaining to the required structure or content of the data analytics request 236, such as required or expected parameters or arguments. In some examples, the input validation portion is designed to identify and prevent malicious requests from being executed by the tool 212.

The code generation portion includes instructions and/or few-shot examples pertaining to the required structure or content of the code 242, such as clause or statement definitions and instructions for mapping input to clauses or statements that are executable by the tool 212. In some examples, the code generation portion includes a GMLM instruction to output reasoning along with the code 242, where the reasoning includes information about steps performed by the GMLM to generate the code 242.

The output validation portion includes information and/or few-shot examples pertaining to the required structure or format of the tool output 246 received from the tool 212 in response to the code 244. In some examples, the output validation portion includes a GMLM instruction to perform an aggregation on the tool output 246 and return the aggregation to the input augmentation sub-agent 206 along with reasoning, where the reasoning includes information about steps performed by the GMLM to generate the aggregation. Additional examples of instruction 240 are described with reference to FIG. 3, FIG. 4A, and FIG. 4B.

To generate the code 242, the input augmentation sub-agent 206 sends the instruction 240 to the GMLM 210. The GMLM 210 receives and processes the instruction 240 using data store(s) 214 to generate and output the code 242 in accordance with the instruction 240.

The input augmentation sub-agent 206 receives the code 242 from the GMLM 210 and formulates the code 244. In some examples, formulating the code 244 from the code 242 includes inserting the code 242 into an API call, function call, or other type of messaging structure. The input augmentation sub-agent 206 sends the code 244 to the tool 212 (e.g., the input augmentation sub-agent 206 invokes the tool 212 with the code 244 as an argument). Responsive to the code 244, the tool 212 executes the code 244 using data store(s) 214 and returns tool output 246 to input augmentation sub-agent 206.

Using the tool output 246, the input augmentation sub-agent 206 formulates input augmentation data 250 and provides the input augmentation data 250 to the input augmentation agent 202 in response to the data analytics request 236. In some examples, the input augmentation data 250 includes an aggregation or summarization of the tool output 246. For instance, the tool output 246 could include a number of data records matching a search criterion contained in the code 244, which is aggregated or summarized by the input augmentation sub-agent 206. In some examples, the input augmentation sub-agent 206 interacts with GMLM 210 to produce the input augmentation data 250 (e.g., the input augmentation sub-agent 206 sends the tool output 246 to the GMLM 210 with an instruction to perform the requested aggregation or summarization). In other examples, the code 244 is formulated to cause the tool 212 to prepare the tool output 246 in the form of an aggregation or summarization (e.g., a synthesis of query results) rather than as a set of query results.

The input augmentation sub-agent 206 includes an eval-iterate component 248. The eval-iterate component 248 is invoked by the input augmentation sub-agent 206 as needed to evaluate input received by the input augmentation sub-agent 206 (e.g., data analytics request 236) or output generated via the input augmentation sub-agent 206 (e.g., code 242, input augmentation data 250) according to one or more validation criteria before the input or output is used in a subsequent step or process. The validation criteria are specific to the particular type of input or output being validated and the purpose of its subsequent use. As such, the validation criteria are configurable according to the requirements of a particular design or implementation of the computing system. The input augmentation sub-agent 206 obtains the validation criteria applicable to a given input or output from, e.g., instruction library 208 or another data store.

In some examples, the eval-iterate component 248 of input augmentation sub-agent 206 evaluates the data analytics request 236, e.g., to ensure that the request 236 is of a type that the input augmentation sub-agent 206 is capable of processing and does not contain any malicious statements. In some examples, the eval-iterate component 248 evaluates the code 242 received from GMLM 210, e.g., to ensure that the code 242 contains statements and/or clauses that are capable of being processed by the tool 212. In some examples, the eval-iterate component 248 evaluates tool output 246 and/or input augmentation data 250 before providing the tool output 246 and/or input augmentation data 250 to input augmentation agent 202 to ensure that tool output 246 and/or input augmentation data 250 contains a threshold amount of analytics data (e.g., at least a minimum number of query results). In some examples, the eval-iterate component 248 evaluates tool output 246 and/or input augmentation data 250 before providing the tool output 246 and/or input augmentation data 250 to input augmentation agent 202 to ensure that the tool output 246 and/or input augmentation data 250 does not include invalid information such as information that is not pertinent to the data analytics request 236.

If the eval-iterate component 248 detects an invalid piece of input or output, the eval-iterate component 248 returns an error to the input augmentation sub-agent 206. In response to an error message from the eval-iterate component 248, the input augmentation sub-agent 206 repeats the process that produced the invalid piece of input or output with revised instructions or returns an error to the input augmentation agent 202. If code 242 generated by the GMLM 210 does not meet or exceed applicable validation criteria, in some examples the input augmentation sub-agent 206 revises the instruction 240 and provides the revised instruction to the GMLM 210. If the tool output 246 and/or input augmentation data 250 does not meet or exceed applicable validation criteria, the input augmentation sub-agent 206 sends a response to the input augmentation agent 202 that prompts the input augmentation agent 202 to revise or supplement the data analytics request 236. The eval-iterate component 248 is depicted using dashed lines because it may or may not iterate in a given instance. For instance, if the piece of input or output being evaluated meets or exceeds applicable validation criteria, then the eval-iterate component 248 does not repeat the evaluation/validation process.

The asynchronous sub-task 272 is similar to the asynchronous sub-task 270 except that it processes a different data analytics request 252 using a different input augmentation sub-agent 216 (e.g., a different instance of sub-agent 206 or a different sub-agent altogether). In the asynchronous sub-task 272, the input augmentation sub-agent 216 receives data analytics request 252 from input augmentation agent 202. Responsive to the data analytics request 252, the input augmentation sub-agent 216 formulates an instruction 256. The instruction 256 includes one or more sub-instructions and/or few-shot examples that pair various types of data analytics requests with corresponding code, which the GMLM 218 uses to generate the code 258.

The code 258 is generated and output by the GMLM 218 in response to the instruction 256. To generate the code 258, the GMLM 218 formulates and outputs clauses or statements using a structured language such as a programming language or query language that is capable of being read and executed by the tool 220. The purpose of the code 258 is to cause the tool 220 to produce tool output 262 that is responsive to the data analytics request 252. In some examples, the code 258 includes one or more clauses or statements that are written in a structured query language, where the clauses have been formulated by the GMLM 218 based on corresponding portions of the data analytics request 252.

The tool 220 is different from the tool 212 in some examples. For instance, in formulating the data analytics requests 236, 252, the input augmentation agent 202 determines that a response to the data analytics request 236 is capable of being produced by executing a first type of query on a first type of database (e.g., using structured query language and a relational database) while a response to the data analytics request 252 is capable of being produced by executing a second type of query on a second type of database (e.g., using a graph query and a graph database). In this example, the input augmentation sub-agent 206 formulates instruction 240 to cause the GMLM 210 to generate code 242 in a structured query language that can be executed by tool 212 on a relational database while the input augmentation sub-agent 216 formulates instruction 256 to cause the GMLM 218 to generate code 258 as a graph query that can be executed by tool 220 on a graph database.

In some examples, to formulate the instruction 256, the input augmentation sub-agent 216 retrieves a code generation template from instruction library 209 and merges the data analytics request 252 with the code generation template (e.g., by mapping portions of the data analytics request 252 to corresponding arguments or parameters in the code generation template).

In some examples, the code generation template used to formulate the instruction 256 includes one or more of an input validation portion, a code generation portion, and an output validation portion. The input validation portion includes information and/or few-shot examples pertaining to the required structure or content of the data analytics request 252, such as required or expected parameters or arguments. In some examples, the input validation portion is designed to identify and prevent malicious requests from being executed by the tool 220.

The code generation portion includes instructions and/or few-shot examples pertaining to the required structure or content of the code 258, such as clause or statement definitions and instructions for mapping input to clauses or statements that are executable by the tool 220. In some examples, the code generation portion includes a GMLM instruction to output reasoning along with the code 258, where the reasoning includes information about steps performed by the GMLM to generate the code 258.

The output validation portion includes information and/or few-shot examples pertaining to the required structure or format of the tool output 262 received from the tool 220 in response to the code 260. In some examples, the output validation portion includes a GMLM instruction to perform an aggregation on the tool output 262 and return the aggregation to the input augmentation sub-agent 216 along with reasoning, where the reasoning includes information about steps performed by the GMLM 218 to generate the aggregation. Additional examples of instruction 256 are described with reference to FIG. 3, FIG. 4A, and FIG. 4B.

To generate the code 258, the input augmentation sub-agent 216 sends the instruction 256 to the GMLM 218. The GMLM 218 receives and processes the instruction 256 using data store(s) 222 to generate and output the code 258 in accordance with the instruction 256.

The input augmentation sub-agent 216 receives the code 258 from the GMLM 218 and formulates the code 260. In some examples, formulating the code 260 from the code 258 includes inserting the code 258 into an API call, function call, or other type of messaging structure. The input augmentation sub-agent 216 sends the code 260 to the tool 220 (e.g., the input augmentation sub-agent 216 invokes the tool 220 with the code 260 as an argument). Responsive to the code 260, the tool 220 executes the code 260 using data store(s) 222 and returns tool output 262 to input augmentation sub-agent 216.

Using the tool output 262, the input augmentation sub-agent 216 formulates input augmentation data 266 and provides the input augmentation data 266 to the input augmentation agent 202 in response to the data analytics request 252. In some examples, the input augmentation data 266 includes an aggregation or summarization of the tool output 262. For instance, the tool output 262 could include a number of data records matching a search criterion contained in the code 260, which is aggregated or summarized by the input augmentation sub-agent 216. In some examples, the input augmentation sub-agent 216 interacts with GMLM 218 to produce the input augmentation data 266 (e.g., the input augmentation sub-agent 216 sends the tool output 262 to the GMLM 218 with an instruction to perform the requested aggregation, synthesis, or summarization). In other examples, the code 258, 260 is formulated to cause the tool 220 to prepare the tool output 262 in the form of an aggregation or summarization (e.g., a synthesis of query results) rather than as a set of query results.

The input augmentation sub-agent 216 includes an eval-iterate component 264. The eval-iterate component 264 is invoked by the input augmentation sub-agent 216 as needed to evaluate input received by the input augmentation sub-agent 216 (e.g., data analytics request 252) or output generated via the input augmentation sub-agent 216 (e.g., code 258, input augmentation data 266) according to one or more validation criteria before the input or output is used in a subsequent step or process. The validation criteria are specific to the particular type of input or output being validated and the purpose of its subsequent use. As such, the validation criteria are configurable according to the requirements of a particular design or implementation of the computing system. The input augmentation sub-agent 216 obtains the validation criteria applicable to a given input or output from, e.g., instruction library 209 or another data store.

In some examples, the eval-iterate component 264 of input augmentation sub-agent 216 evaluates the data analytics request 252, e.g., to ensure that the request 252 is of a type that the input augmentation sub-agent 216 is capable of processing and does not contain any malicious statements. In some examples, the eval-iterate component 264 evaluates the code 258 received from GMLM 218, e.g., to ensure that the code 258 contains statements and/or clauses that are capable of being processed by the tool 220. In some examples, the eval-iterate component 264 evaluates tool output 262 and/or input augmentation data 266 before providing the tool output 262 and/or input augmentation data 266 to input augmentation agent 202 to ensure that tool output 262 and/or input augmentation data 266 contains a threshold amount of analytics data (e.g., at least a minimum number of query results). In some examples, the eval-iterate component 264 evaluates tool output 262 and/or input augmentation data 266 before providing the tool output 262 and/or input augmentation data 266 to input augmentation agent 202 to ensure that the tool output 262 and/or input augmentation data 266 does not include invalid information such as information that is not pertinent to the data analytics request 252.

If the eval-iterate component 264 detects an invalid piece of input or output, the eval-iterate component 264 returns an error to the input augmentation sub-agent 216. In response to an error message from the eval-iterate component 264, the input augmentation sub-agent 216 repeats the process that produced the invalid piece of input or output with revised instructions or returns an error to the input augmentation agent 202. If code 258 generated by the GMLM 218 does not meet or exceed applicable validation criteria, in some examples the input augmentation sub-agent 216 revises the instruction 256 and provides the revised instruction to the GMLM 218. If the tool output 262 and/or input augmentation data 266 does not meet or exceed applicable validation criteria, the input augmentation sub-agent 216 sends a response to the input augmentation agent 202 that prompts the input augmentation agent 202 to revise or supplement the data analytics request 252. The eval-iterate component 264 is depicted using dashed lines because it may or may not iterate in a given instance. For instance, if the piece of input or output being evaluated meets or exceeds applicable validation criteria, then the eval-iterate component 264 does not repeat the evaluation/validation process.

Responsive to the completion of the asynchronous sub-tasks 270, 272, the input augmentation agent 202 receives the input augmentation data 250, 266 from the respective input augmentation sub-agents 206, 216. In some examples, the input augmentation agent validates the input augmentation data 250, 266 using the eval-iterate component 269. The input augmentation agent 202 prepares input augmentation data 251 using the input augmentation data 250 and/or the input augmentation data 266, such that the input augmentation data 251 includes a combination of input augmentation data 250 and input augmentation data 266 or a subset of one or more of input augmentation data 250 and input augmentation data 266.

The input augmentation agent 202 sends the input augmentation data 251 to GMLM 204. GMLM 204 generates and outputs one or more machine learning-based representations (MLBR) 267 of the input augmentation data 251 using data store(s) 205 as needed. In some examples, the input augmentation agent 202 validates the MLBR 267 using eval-iterate component 269.

The input augmentation agent 202 generates learnings 268 using the MLBR 267. In some examples, the learnings 268 include combinations or subsets of the MLBR 267 received from GMLM 204. The input augmentation agent 202 stores the learnings 268 in data store(s) 224 or provides the learnings 268 directly to the source of the input augmentation request 201 (e.g., a supervisor agent, a task agent, or a component of an environment, such as a device, network, or sensor).

Each or any of eval-iterate components 248, 264, 269 include or interact with one or more machine learning models (e.g., machine learning model(s) 152) to perform evaluation and validation processes, in some examples. A machine learning-based classifier is used to classify or categorize the input or output being evaluated as invalid or valid, in some examples. In other examples, one or more of the GMLMs 204, 210, 218 are used to rate, rank, or categorize the input or output being evaluated. In other examples, a rules engine or heuristics are used to determine whether the input or output being evaluated meets or exceeds the applicable validation criteria.

The examples shown in FIG. 2 and the accompanying description are provided for illustration purposes. This disclosure is not limited to the described examples.

FIG. 3 is a component-based flow diagram of an example method for generating input augmentation data using an agent in accordance with some examples of the present disclosure. For instance, FIG. 3 illustrates a method 300, which includes operations performed by an input augmentation sub-agent 304.

The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 300 is performed by the computing system components shown in FIG. 3. In other examples, portions of the method 300 are performed by the computing system components shown in FIG. 1, FIG. 2, FIG. 4A, FIG. 4B, FIG. 5, FIG. 6, one or more components of computing system 700 of FIG. 7, and/or agent system 950 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 3, the method 300 is represented by arrows connecting components of a computing system. Examples of computing systems including agents such as the agent shown in FIG. 3 are described with reference to FIG. 7 and FIG. 9. The agentic system of FIG. 3 includes a device, agent, network, etc. 301, an API/front end 302, an input augmentation agent sub-agent 304, an instruction library 316, a generative machine learning model (GMLM) 318, a tool 320, and one or more data stores 322.

The device, agent, network, etc. 301, is capable of performing the same or similar functionality as described above, e.g., with reference to components of an environment (e.g., the environment 101), a supervisor agent (e.g., supervisor agent 106), an input augmentation agent (e.g., input augmentation agent 108, 202), or a task agent (e.g., task agent(s) 112).

The API/front end 302 is capable of performing the same or similar functionality as described above, e.g., with reference to a device interface (e.g., device interface 102) or application programming interface.

The input augmentation sub-agent 304 is capable of performing the same or similar functionality as described above, e.g., with reference to input augmentation sub-agent(s) 110, 206, 226 (also referred to as analytics agents or skill agents), alternatively or in addition to functionality described in more detail below. The instruction library 316 is capable of performing the same or similar functionality as described above, e.g., with reference to instruction library (ies) 208, 209, alternatively or in addition to functionality described in more detail below. The generative machine learning model (GMLM) 318 is capable of performing the same or similar functionality as described above, e.g., with reference to machine learning model(s) 152, 204, 210, 218, alternatively or in addition to functionality described in more detail below. The tool 320 is capable of performing the same or similar functionality as described above, e.g., with reference to tool(s) 154, 212, 220, alternatively or in addition to functionality described in more detail below. The data store(s) 322 are each capable of providing the same or similar information and/or functionality as described above, e.g., with reference to data store(s) 150, 205, 214, 222, alternatively or in addition to functionality described in more detail below.

The input augmentation sub-agent 304 includes an instruction generator 306 and a code executer 314. The instruction generator 306 obtains instructions 328 (e.g., GMLM prompts and/or prompt templates) from instruction library 316 from time to time and generates corresponding GMLM instructions 330 for the input augmentation sub-agent 304. An example of a prompt template, also referred to as a wrapper prompt, including input validation, parameter validation, and code generation sub-instructions, is described with reference to FIG. 4A. An example of an application of the wrapper prompt (e.g., input validation, parameter validation, and code generation sub-instructions) to a data analytics request is described with reference to FIG. 4B.

The instruction generator 306 includes an input validation component 308, a parameter validation component 309, a code generation component 310, and an output validation component 312, each of which generates a portion or sub-instruction of GMLM instructions 330 using portions of instructions 328.

Input validation component 308 generates an input validation sub-instruction of GMLM instructions 330. The input validation sub-instruction is formulated to cause the GMLM 318 to detect invalid portions of input contained in data analytics request 326, such as malicious requests or requests that the tool 320 is not capable of handling. Parameter validation component 309 is a sub-component of input validation component 308 that generates a parameter validation sub-instruction of GMLM instructions 330. The parameter validation sub-instruction is formulated to cause the GMLM 318 to map parameter values contained in the data analytics request 326 to corresponding clauses of code 332. Code generation component 310 generates a code generation sub-instruction of GMLM instructions 330. The code generation sub-instruction is formulated to cause GMLM 318 to generate and output code 332 in response to the code generation sub-instruction. In some examples, the code generation sub-instruction includes an instruction that the GMLM 318 is to use to process certain input values, such as a vocabulary, definition, or dictionary of alternative definitions of query terms. Output validation component 312 generates an output validation sub-instruction of GMLM instructions 330. The output validation sub-instruction is formulated to cause GMLM 318 to validate tool output 336 before the tool output 336 is included in input augmentation data 340.

In operation, a data analytics request 321 is received via API/front end 302 from device, agent, network, etc. 301. The data analytics request 321 includes input and/or metadata (e.g., input 120, metadata 122). Responsive to the data analytics request 321, the API/front end 302 invokes input augmentation sub-agent 304 with data analytics request 326. Data analytics request 326 includes data analytics request 321 or is a reformulated version of data analytics request 321 that is capable of being processed by the input augmentation sub-agent 304.

In response to the data analytics request 326, input augmentation sub-agent 304 retrieves instructions 328 related to the request 326 from instruction library 316 and prepares GMLM instructions 330, e.g., by merging portions of the data analytics request 326 with instructions 328. The instruction generator 306 formulates an input validation sub-instruction of GMLM instructions 330. In some examples, the input validation sub-instruction includes a parameter validation sub-instruction formulated by the parameter validation component 309. The code generation component 310 prepares a code generation sub-instruction of GMLM instructions 330. The code generation sub-instruction includes portions of the data analytics request 326 that are to be converted into code 332 by the GMLM 318, such as query terms. The input augmentation sub-agent 304 sends GMLM instructions 330 containing the input validation sub-instruction, the parameter validation sub-instruction, and the code generation sub-instruction (including associated merged portions of the data analytics request 326) to the GMLM 318.

In response to the GMLM instructions 330 containing the input validation sub-instruction, the parameter validation sub-instruction and the code generation sub-instruction, the GMLM generates and outputs code 332 or error message 333.

The code executer 314 receives code 332 or error message 333 generated by GMLM 318 in response to code generation instructions produced by code generation component 310 of instruction generator 306. Code executer 314 provides code 334 to tool 320 for execution by the tool 320. Alternatively, code executer 314 processes error message 333 into error message 341 (e.g., by reformatting error message 333 using a messaging protocol) and provides error message 341 to API/front end 302. The code 334 includes the code 332. In some examples, the code executer 314 creates the code 334 by inserting the code 332 into, e.g., an API call.

The tool 320 executes the code 334 using data store(s) 322 to generate tool output 336. Examples of tool output 336 include search results and aggregations of search results. The tool 320 provides the tool output 336 to output validation component 312 of the input augmentation sub-agent 304.

Output validation component 312 performs a validation process on the tool output 336 via eval-iterate component 338. The eval-iterate component 338 is capable of performing the same or similar functionality as described above, e.g., with reference to eval-iterate component 248, 264, 269, alternatively or in addition to functionality described in more detail below. If the tool output 336 does not meet or exceed the applicable validation criteria, the output validation component 312 provides a result of the validation process (e.g., feedback received from the eval-iterate component 338, such as an indication that the tool output 336 contains an insufficient number of query results) to the instruction generator 306 to cause the instruction generator 306 to repeat the process of interacting with GMLM 318 to generate revised code 332 and causing the tool 320 to execute revised code 334 to produce revised tool output 336. The eval-iterate component 338 repeats the validation process iteratively as needed until the tool output 336 meets or exceeds the applicable validation criteria.

In some examples, the eval-iterate component 338 includes the output validation component 312 communicating an output validation sub-instruction of GMLM instructions 330 to GMLM 318. Responsive to the output validation sub-instruction, the GMLM 318 returns an output validation result to eval-iterate component 338 which the eval-iterate component 338 uses to determine whether the applicable validation criteria is met.

In some examples, the input augmentation sub-agent 304 provides a generalized skill that allows the device, agent, network, etc. 301 to query data and/or analytics (e.g., various types of statistics) from one or more domain-specific data stores (e.g., logs of user interaction history).

In some examples, the input augmentation sub-agent 304 provides a specific skill that determines implicit preferences from among multiple entity profiles (e.g., the input augmentation sub-agent 304 is used to identify entity attributes that are frequently associated with certain types of interactions, within a particular group of entities.

In some examples, the input augmentation sub-agent 304 provides the ability to dynamically adapt the code 332 to similar data analytics requests 326 by including context data in the code 332 and/or including a range of valid sample sizes to be returned in the code 332. For instance, if code 332 includes a query that is too specific (e.g., narrow) then execution of the code 332 by tool 320 could return zero search results but if code 332 includes a query that is too general (e.g., broad) then execution of the code by tool 320 could return too many search results.

In some examples, the input augmentation sub-agent 304 provides the ability to analyze data about entities that a specific user of an application software system has accessed or interacted with. In some examples, the input augmentation sub-agent 304 is capable of formulating GMLM instructions 330 to generate code 332 that is executable by tool 320 to provide tool output 336 that is responsive to a data analytics request 321 such as “what is the ratio of people that I send messages to versus the number of messages that I dismiss?”

In addition to being able to perform user-specific data analytics on direct queries, the input augmentation sub-agent 304 is capable of analyzing similar data. For instance, if a data analytics request 321 asks “how many AI engineers did I hire with 3+ years of ML experience?” the input augmentation sub-agent 304 formulates GMLM instructions 330 to cause GMLM 318 to generate code 332 executable by tool 320 to return and analyze engineers hired by the user with 3+ years of “machine learning experience,” “ML experience,” “AI engineers,” “artificial intelligence engineers,” “large language model experience,” “LLM experience,” etc. In this example, the instruction generator 306 automatically expands the data analytics request 326 to include additional query terms, e.g., by automatically generating the above vocabulary at runtime time based on the user's historical data (using, e.g., a retrieval augmented generation technique) and including the vocabulary in the GMLM instructions 330. This and other examples illustrate how the GMLM instructions 330 are generated and modified at runtime, using, e.g., RAG databases, to include information about the current context such as the user's most recent interaction history.

In some examples, the instruction generator 306 formulates GMLM instructions 330 to detect a malicious statement in the data analytics request 321, 326 and prevent the malicious statement from being executed by the tool 320. For instance, a data analytics request 321, 326 could include a request to perform a task, including, embedded within that request, a command received from the device, agent, network, etc. 301, to delete data from the data store(s) 322. In this example, the GMLM instructions 330 enable the GMLM 318 to detect that the malicious statement does not map to any valid code parameters, statements or clauses and exclude the detected malicious statement from the code 332 or return an error message 333. In these and/or other ways, the input validation component 308, parameter validation component 309, and code generation component 310 reduce the likelihood that malicious attempts to access data in data store(s) 322 will be executed by the tool 320.

In some examples, the data analytics request 321, 326 includes metadata collected and stored in previous iterations of the input augmentation sub-agent 304, such as search results and activities taken by the user on search results. The input augmentation sub-agent 304 includes this metadata in GMLM instructions 330 and formulates GMLM instructions 330 to include an instruction to cause the GMLM 318 to determine user preferences given the metadata (e.g., to identify the user's preferred search criteria, filters, or sorting preferences).

In some examples, the instruction generator 306 includes a data store selection sub-instruction in the GMLM instructions 330. The data store selection sub-instruction identifies valid data store(s) 322 or portion(s) of a data store (e.g., fields or columns) for a particular data analytics request. The data store selection sub-instruction provides criteria that the GMLM 318 is to use to select, from among the valid data store(s) 322, a selected data store to use to generate input augmentation data 340 that responsive to a given data analytics request 321, 326. For instance, given a data analytics request 321, 326 such as “get me all projects for SW engineers by looking at metadata fields,” the instruction generator 306 formulates a GMLM instruction 330 that causes the GMLM 318 to generate and output a query that when executed by the tool 320 on the data store(s) 322 selects projects by searching only the metadata fields and not other fields of the data records for the keyword SWE. These and other examples illustrate how the data sources used to generate input augmentation are dynamically selected at runtime based on the particulars of a given data analytics request 321, 326.

In some examples, the instruction generator 306 formulates GMLM instructions 330 to include an instruction to cause the GMLM 318 to return reasoning in addition to code 332 and/or error message 333. The reasoning provides an explanation of the steps performed by the GMLM 318 to generate the code 332 or error message 333. The reasoning is generated by the GMLM 318 using portions of the GMLM instructions 318. For instance, if the GMLM instructions 318 include rules for selecting a data store 322 and an instruction to output reasoning, the GMLM 318 includes in its output returned to the input augmentation sub-agent 304 an explanation of the rules that were used to select the data store. In another instance, the instruction generator 306 formulates GMLM instructions 330 to include alternative definitions of a query term such as “PhD” and an instruction to output reasoning. In this instance, the GMLM 318 outputs the particular definition of “PhD” it selected from among the alternative definitions provided in the GMLM instructions 330 to include in the code 332. Using the eval-iterate component 338, if the first definition used by the GMLM 318 to generate a query included in the code 332 produces zero search results, then, given the feedback of zero results, on a subsequent iteration the GMLM 318 is able to select an alternative or additional definition to expand the query.

To process GMLM instructions 330, the GMLM 318 automatically converts the GMLM instructions 330 from a natural language form to a structured form (e.g., query language or programming language), selects the data store(s) 322 that the tool 320 is to use to execute the code 332, and formulates and outputs the code 332. To perform input validation on the data analytics request 326, the input validation sub-instructions cause the GMLM 318 to decompose or parse the data analytics request 326 into parameters, clauses or statements using a template provided in the GMLM instructions 330. Through this decomposition process, any portions of the data analytics request 326 that do not fit into template are discarded and thereby omitted from the code 332 or prevented from being executed when the tool 320 executes the code 334.

In some examples, the various portions and sub-instructions of the GMLM instructions 330 are formulated by the instruction generator 306 as intermediate steps of a larger GMLM prompt using a chain of thought reasoning approach. In some examples, all of the portions and sub-instructions of the GMLM instructions 330 are contained in a single multi-step prompt where output of each step is used as input to one or more subsequent steps of the prompt. The GMLM instructions 330 are formulated using one or multiple calls to the GMLM 318, in accordance with the requirements of a particular design or implementation of the computing system. The number of calls to the GMLM 318 is adjustable as needed to, e.g., improve latency or scalability of the input augmentation sub-agent 304.

In some examples, using the chain of thought reasoning approach, each of the intermediate steps (e.g., sub-instructions) is a separate call to the GMLM 318. In these examples, the ‘wrapper’ portion of the prompt (e.g., template definitions, data store(s), output format, tool-specific sub-instructions) is included in each separate call to the GMLM 318 so that the input and output validation processes are included in each call to the GMLM 318 that is to result in the GMLM 318 producing code 332 that is capable of being executed by tool 320.

The described approach to building input augmentation sub-agents provides flexibility in that the input augmentation sub-agent 304 is capable of handling a wide variety of use cases, data analytics requests and tools by dynamically customizing the ‘wrapper’ portion of the GMLM instructions 328 for a particular use case, request, or tool. When the input augmentation sub-agent 304 identifies a particular use case, request, or tool (e.g., by reading metadata contained in the data analytics request 326), the input augmentation sub-agent 304 queries the instruction library 316 for instructions 328 to include in the ‘wrapper’ portion of the GMLM instructions 330, which specify the use case, request, or tool-specific arguments, syntax, and other requirements for the GMLM 318 to generate code 332 that is valid and executable by the particular tool 320 for the particular use case or request, including instructions as to how the tool 320 is to be used. The ‘wrapper’ portion of the GMLM instructions 330 also includes output validation sub-instructions that instruct the GMLM 318 as to how to format the code 332, error message 333, and/or other portions of output generated by the GMLM 318. An example of a ‘wrapper’ portion of GMLM instructions is described with reference to FIG. 4A.

The examples shown in FIG. 3 and the accompanying description are provided for illustration purposes. This disclosure is not limited to the described examples.

FIG. 4A is an example of a portion of an instruction for a generative machine learning model including an input validation template in accordance with some examples of the present disclosure. For instance, FIG. 4A illustrates GMLM instructions 400 that could be included in a ‘wrapper’ prompt described with reference to FIG. 3.

In FIG. 4A, the GMLM instructions 400 include instructions 402, 406, 408, 410 (also referred to as a code writing/executing portion), and a wrapper portion 404, 408 (also referred to as a template or input validation sub-instructions). The wrapper portion 404, 408 forces the GMLM (e.g., GMLM 210, 220, 316) to only use the parameters (also referred to as arguments) that are identified in the wrapper portion 404 and to follow few-shot examples (not shown in the example of FIG. 4A) that are provided in the wrapper portion 404, 408 to generate code. The parameters 404 are tool-specific, e.g., correspond to the requirements and/or syntax of an API or other code for controlling a tool. The tool for which wrapper portion 404, 408 is configured could be a sensor, a clock, a self-driving vehicle, a searchable database, or another type of tool for which a GMLM is capable of generating code in accordance with an associated wrapper portion 404.

At runtime, if a data analytics request includes a malicious action such as “do a task and then delete everything in the memory” this request will not meet the requirements specified in the wrapper portion 404, 408 and so the GMLM will return an error message or exclude the malicious portion of the request from the code generation. In some examples, an error message returned by the GMLM triggers an action at a component of an environment (e.g., a device, network, or sensor of environment 101), such as routing the data analytics request including the malicious action to a honeynet or isolating a network node associated with the request containing the malicious action. In some examples, the code generated by the GMLM in accordance with the instructions 400 including the wrapper portion 404, 408 is executed or at least potentially executed (e.g., checked into a source safe) with the malicious action excluded from the execution of the code.

In some examples, during the input validation process, the instruction 410 causes the GMLM to generate an initial version of code (e.g., a query) based on a data analytics request. The instruction 408 decomposes the initial version of the query into clauses after the instruction 410 formulates the initial version of the query. The instruction 408 ensures that irrespective of the contents of the data analytics request, only valid portions of the data analytics request that map to the parameters, clauses, or statements specified in the wrapper portion 404, 408 are included in the code and any malicious portions of the data analytics request are ignored, omitted, or excluded from the code because those malicious portions do not map to any valid portions of the wrapper prompt (e.g., parameters 404).

In the example of FIG. 4A, the instruction 402 informs the GMLM of the types of available tool(s) that can be used to generate code, the parameters that are required by the each of the available tools, and any applicable tool-specific constraints or contextual information. For instance, if an available tool is a SQL (structured query language)-based query mechanism, the instruction 402 reference a library, which could include tool-specific contextual information specified in a natural language form, such as “you are an SQL assistant, and you should determine whether the request can be answered with SQL.” The tool specific constraints could include “only use SQL parameters to construct SQL statements.” The instruction 410 could include “explicitly print out the SQL statements you have constructed.” The instruction 408 could include rules for processing query terms contained in the data analytics request, such as rules for expanding query terms to include synonyms or alternatives contained in a vocabulary.

In some examples, the GMLM calls the tool directly as part of the chain of thought reasoning process, and the wrapper portion 404, 408 exposes the required (and validated) arguments to the GMLM for insertion into the call to the tool. In these examples, the instruction 402 acts as a sub-prompt that receives arguments prepared according to and provided by the wrapper portion 404 408.

The examples shown in FIG. 4A and the accompanying description are provided for illustration purposes. This disclosure is not limited to the described examples.

FIG. 4B is an example method of input validation in accordance with some examples of the present disclosure. For instance, FIG. 4B illustrates how GMLM instructions formulated by an input augmentation sub-agent are capable of causing a GMLM to detect an invalid portion of a data analytics request and generate code only based on valid portions of the data analytics request and/or generate an error.

In FIG. 4B, a data analytics request 422 is received from an agent or a component of an environment (e.g., a component of environment 101). The data analytics request 422 includes a valid request 424 and an invalid request 426, although those portions of the request 422 are not identified as such in the request 422 but rather are detected via the validation processes applied to the request 422 by an input augmentation sub-agent interfacing with a GMLM as described herein. Via GMLM instructions generated by the input augmentation sub-agent, the GMLM generates code 428 corresponding to the valid request 424 and ignores, excludes, or omits the invalid request 426 because the invalid request 426 does not fit within the input validation template provided in the GMLM instructions (e.g., the invalid request 426 does not map to any parameters, statements, or clauses contained in a wrapper portion of the GMLM instructions).

The code 428 is inserted into an API call 430 to a tool for execution by the tool. The invalid request 426 causes the GMLM to generate and output an error 432, which is returned to the input augmentation sub-agent.

As shown in FIG. 4B, using examples of the described techniques, injections of malicious statements into a request that is passed to a GMLM are ignored by the GMLM because the GMLM instructions formulated by the input augmentation sub-agent and provided to the GMLM force the request to fit into a pre-defined template such that any statements that do not fit into the template are ignored or the GMLM returns an indication that it is unable to provide a response to the request.

The examples shown in FIG. 4B and the accompanying description are provided for illustration purposes. This disclosure is not limited to the described examples.

FIG. 5 is a component-based flow diagram of an example method for input augmentation for a software application in accordance with some examples of the present disclosure.

The method 500 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 500 is performed by the computing system components shown in FIG. 5. In other examples, portions of the method 500 are performed by the computing system components shown in FIG. 1, FIG. 2, FIG. 3, FIG. 4A, FIG. 4B, FIG. 6, one or more components of computing system 700 of FIG. 7, and/or agent system 950 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 5, the method 500 is represented by arrows connecting components of an agentic computing system. Examples of computing systems including agentic systems such as the agentic system shown in FIG. 5 are described with reference to FIG. 7 and FIG. 9. The agentic computing system of FIG. 5 includes an API/front end 502, a supervisor agent 504, an input augmentation agent 506, one or more input augmentation sub-agents 508, 510, and a task agent 512.

The API/front end 502 is capable of performing the same or similar functionality as described above, e.g., with reference to API/front end 302 or device interface 102, alternatively or in addition to functionality described in more detail below. The supervisor agent 504 is capable of performing the same or similar functionality as described above, e.g., with reference to supervisor agent 106, alternatively or in addition to functionality described in more detail below.

The input augmentation agent 506 is capable of performing the same or similar functionality as described above, e.g., with reference to input augmentation agent 108, 202, alternatively or in addition to functionality described in more detail below. The input augmentation sub-agent(s) 508, 510 are each capable of performing the same or similar functionality as described above, e.g., with reference to input augmentation sub-agent(s) 110, 206, 216, 304 (also referred to as analytics agents or skill agents), alternatively or in addition to functionality described in more detail below. In some examples, the input augmentation sub-agent(s) 508, 510 are different instances of the same sub-agent while in other examples, the input augmentation sub-agent(s) 508, 510 are different sub-agents. The task agent 512 is capable of performing the same or similar functionality as described above, e.g., with reference to task agent 112, alternatively or in addition to functionality described in more detail below.

In operation, the API/front end 502 passes an input 520 (e.g., “I want to hire an SWE”) to supervisor agent 504. The supervisor agent 504 receives the input 520 and formulates an input augmentation request 522 (“Please help expand ‘SWE”). The supervisor agent 504 sends the input augmentation request 522 to input augmentation agent 506. The input augmentation agent 506 decomposes the input augmentation request 522 into a first data analytics request 524 (“preferred languages (‘SWE,’ software engineer’)? and second data analytics request 528 (“preferred degrees (‘SWE’)?. “The first data analytics request 524 is to determine the implicit preferences of the user submitting the input 520 with respect to programming languages of software engineering job candidates. The second data analytics request 528 is to determine the implicit preferences of the user submitting the input 520 as to educational degrees of software engineering job candidates.

Using the techniques described herein, the input augmentation agent 506 sends the first data analytics request 524 to the input augmentation sub-agent 508 and sends the second data analytics request 528 to the input augmentation sub-agent 510.

In response to the first data analytics request 524, the input augmentation sub-agent 508 formulates GMLM instructions to cause a GMLM to generate and output a query based on the request 524 and cause a tool to execute the query on one or more data stores to produce first input augmentation data 526 (e.g., “10/15 C++”). The first input augmentation data 526 indicates that based on execution by the tool of the query formulated by the GMLM in response to the request 524, most of the user's recent software engineering hires were proficient in the C++ programming language.

In response to the second data analytics request 528, the input augmentation sub-agent 510 formulates GMLM instructions to cause a GMLM to generate and output a query based on the request 528 and cause a tool (e.g., the same tool or a different tool from the tool used by input augmentation sub-agent 508 to process the request 524) to execute the query on one or more data stores to produce second input augmentation data 530 (e.g., “8/15 MS, 15/15 BS, 1/15 PhD”). The second input augmentation data 530 indicates that based on execution by the tool of the query formulated by the GMLM in response to the request 528, most of the user's recent software engineering hires had at least a Bachelor of Science degree and the user has a slight preference for candidates with a Master of Science degree.

The input augmentation sub-agent 508 returns the first input augmentation data 526 to the input augmentation agent 506. The second input augmentation sub-agent 510 returns the second input augmentation data 530 to the input augmentation agent 506.

The input augmentation agent 506 synthesizes a combination of the first input augmentation data 526 and the second input augmentation data 530 (e.g., “SWE” and “C++” and “MS”) into learnings 532. The learnings 532 include one or more machine learning-based representations of the first input augmentation data 526 and the second input augmentation data 530. The input augmentation agent 506 formulates a request including the learnings 532 and sends the request to task agent 512 (e.g., “Find job candidates with ‘SWE’ and ‘C++’ and ‘MS’).

The task agent 512 uses the learnings 532 included in the request 534 to generate and output a task output 536 (e.g., “18 results with ‘SWE’ meaning “software engineer” and “C++” and “MS”). The task agent 512 returns the task output 536 to supervisor agent 504. The supervisor agent 504 incorporates the task output 536 into a task response 538 (e.g., “Here are some SWE candidates. We prioritized candidates with C++ and MS based on your hiring history.”). The supervisor agent 504 provides the task response 538 to API/front end 502. The API/front end 502 returns the task response 538 to the calling agent or provides the task response 538 to a component of an environment, e.g., for presentation via a device in response to the input 520

In the method 500, the process performed by the input augmentation sub-agents 508, 510 are capable of being performed asynchronously, in parallel, e.g., to improve latency.

The examples shown in FIG. 5 and the accompanying description are provided for illustration purposes. This disclosure is not limited to the described examples.

FIG. 6 is a flow diagram of an example method for agentic code generation with validation in accordance with some examples of the present disclosure.

The method 600 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 600 are performed by the computing system components shown in FIG. 1, FIG. 2, FIG. 3, FIG. 4A, FIG. 4B, FIG. 5, one or more components of computing system 700 of FIG. 7, one or more machine learning models of FIG. 8A, FIG. 8B, FIG. 8C, or FIG. 8D, and/or agent system 950 of FIG. 9. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

At operation 610, the processing device, responsive to digital input received in a natural language, formulates an instruction for a generative machine learning model (GMLM). In some examples, the instruction includes an input validation sub-instruction and a code generation sub-instruction. In some examples, portions of operation 610 are performed by an input augmentation sub-agent (e.g., input augmentation sub-agent(s) 110, 206, 216, 304, 508, 510), as described with reference to, e.g., FIG. 1, FIG. 2, FIG. 3, and/or FIG. 5.

At operation 620, the processing device, via processing of the digital input and the code generation sub-instruction by the GMLM, generates and outputs, by the GMLM, code in a programming language. In some examples, the code in the programming language corresponds to or is generated based on the digital input received in the natural language. In some examples, portions of operation 610 are performed by an input augmentation sub-agent (e.g., input augmentation sub-agent(s) 110, 206, 216, 304, 508, 510), as described with reference to, e.g., FIG. 1, FIG. 2, FIG. 3, and/or FIG. 5.

At operation 630, the processing device, via processing of the input validation sub-instruction and the code by the GMLM, detects an unvalidated portion of the digital input. In some examples, portions of operation 610 are performed by an input augmentation sub-agent (e.g., input augmentation sub-agent(s) 110, 206, 216, 304, 508, 510), as described with reference to, e.g., FIG. 1, FIG. 2, FIG. 3, and/or FIG. 5. In some examples, portions of operation 610 are performed by an input augmentation agent (e.g., input augmentation agent 108, 202, 506), as described with reference to, e.g., FIG. 1, FIG. 2, and/or FIG. 5.

At operation 640, the processing device excludes the unvalidated portion of the digital input from an execution of the code generated by the GMLM. In some examples, portions of operation 610 are performed by an input augmentation sub-agent (e.g., input augmentation sub-agent(s) 110, 206, 216, 304, 508, 510), as described with reference to, e.g., FIG. 1, FIG. 2, FIG. 3, and/or FIG. 5. In some examples, portions of operation 610 are performed by an input augmentation agent (e.g., input augmentation agent 108, 202, 506), as described with reference to, e.g., FIG. 1, FIG. 2, and/or FIG. 5.

In some examples, the processing device prevents the execution of the code in response to the detecting of the unvalidated portion of the digital input.

In some examples, the processing device invokes a tool to execute code generated by the GMLM via the code generation sub-instruction and the validated portion of the digital input.

In some examples, the processing device receives output via execution, by the tool, of the code; and via processing of the output of the tool and an output validation sub-instruction by the GMLM, generates and outputs a response to the digital input.

In some examples, the output validation sub-instruction includes a threshold condition and the processing device, responsive to determining that the response does not meet or exceed the threshold condition, causes the GMLM to revise the code generation sub-instruction and generate revised code via processing, by the GMLM, of the digital input and the revised code generation sub-instruction.

In some examples, the response to the digital input includes an implicit preference derived by the GMLM from the output of the tool, and the processing device uses the implicit preference to control an application system and/or a device. In some examples, the application system includes an entity matching component that uses the implicit preference to identify digital entities that match criteria. In some examples, the device includes an autonomous or semi-autonomous component that uses the implicit preference to determine an action to be performed by the autonomous or semi-autonomous component.

In some examples, the processing device causes the GMLM to include, in the response to the digital input, reasoning related to the generation of the code by the GMLM. In some examples, the reasoning includes a portion of the code generation sub-instruction.

In some examples, the input validation sub-instruction identifies standard clauses to the GMLM and the processing device detects the unvalidated portion of the digital input by, via the GMLM, decomposing the code generated by the GMLM into code clauses and mapping the code clauses to a standard clause of the standard clauses. In some examples, the standard clauses are arguments of an application programming interface and/or the standard clauses are listed in the input validation sub-instruction.

In some examples, the processing device, responsive to detecting the unvalidated portion of the digital input, generates and outputs an error message.

The examples shown in FIG. 6 and the accompanying description are provided for illustration purposes. This disclosure is not limited to the described examples.

FIG. 7 is a block diagram of a computing system that includes input augmentation in accordance with some examples of the present disclosure.

In the example of FIG. 7, a computing system 700 includes one or more user systems 710, a network 720, an application system 730, data resources and tools 750, an agent system 780, a data storage system 760, an event logging service 770, and an AI model service 790.

All or at least some components of agent system 780 are implemented at the user system 710, in some examples. For example, portions of agent system 780 are implemented directly upon a single client device such that communications involving applications running on user system 710 and agent system 780 occur on-device without the need to communicate with, e.g., one or more servers, over the Internet. Dashed lines are used in FIG. 7 to indicate that all or portions of agent system 780 are capable of being implemented directly on the user system 710, e.g., the user's client device. In some examples, both user system 710 and agent system 780 are implemented on the same computing device, in some examples. In other examples, all or portions of agent system 780 are implemented on one or more servers and in communication with user systems 710 via network 720. Components of the computing system 700 including the agent system 780 are described in more detail herein.

A user system 710 includes one or more computing devices. Examples of computing devices include a personal computing device, a server, a mobile computing device, a wearable electronic device, or a smart appliance. The user system 710 includes one or more software applications that a computing device is capable of executing alone or in combination with one or more other computing devices. Examples of software applications include an operating system or a front end of an online system. Many different user systems 710 are capable of being connected to network 720 at the same time or at different times. In some examples, different user systems 710 contain similar components as described in connection with the illustrated user system 710. In some examples, many different end users of computing system 700 interact with many different instances of application system 730 through their respective user systems 710, at the same time or at different times.

User system 710 includes a user interface 712. User interface 712 is installed on user system 710 or accessible to user system 710 via network 720. In some examples, user interface 712 includes a front end portion of a search application or agent system.

User interface 712 includes, for example, a graphical display screen that includes graphical user interface elements. Examples of graphical user interface elements include an input box or other input mechanism and a slot. A slot as used herein refers to a space on a graphical display such as a web page or mobile device screen, into which output, e.g., digital content such as search results, feed items, chat boxes, or threads, is loaded for display to the user. In some examples, user interface 712 includes a scrollable arrangement of variable-length slots that simulates an online chat or instant messaging session and/or a scrollable arrangement of slots that contain content items or search results. The locations and dimensions of a particular graphical user interface element on a screen are specified using, for example, a markup language such as HTML (Hypertext Markup Language). On a typical display screen, a graphical user interface element is defined by two-dimensional coordinates. In other examples such as virtual reality or augmented reality examples, a slot is defined using a three-dimensional coordinate system. Example screen captures of user interface screens that are capable of being included in user interface 712 are shown in the drawings and described herein.

User interface 712 is capable of interacting with the agent system 780 and/or one or more application systems 730. For example, user interface 712 enables the user of a user system 710 to interact with the agent system 780 to create, edit, send, view, receive, process, and organize projects, tasks, plans, search queries, search results, content items, news feeds, and/or portions of online dialogs. In some examples, user interface 712 enables the user to input requests (e.g., queries) for various different types of information, to initiate user interface events, and to view or otherwise perceive output such as data and/or digital content produced by, e.g., an application system 730, agent system 780, content distribution service 738 and/or search engine 740. In some examples, user interface 712 includes a graphical user interface (GUI), a conversational voice/speech interface, a virtual reality, augmented reality, or mixed reality interface, and/or a haptic interface. User interface 712 includes a mechanism for entering search queries and/or selecting search criteria (e.g., facets, filters, etc.), selecting GUI user input control elements, and interacting with digital content such as search results, entity profiles, posts, articles, feeds, and online dialogs, in some examples. Some examples of user interface 712 include web browsers, command line interfaces, and mobile app front ends. User interface 712 as used herein includes application programming interfaces (APIs) in some examples.

Network 720 includes an electronic communications network. Network 720 is implemented on any medium or mechanism that provides for the exchange of digital data, signals, and/or instructions between the various components of computing system 700. Examples of network 720 include, without limitation, a Local Area Network (LAN), a Wide Area Network (WAN), an Ethernet network or the Internet, or a terrestrial, satellite or wireless link, or a combination of any number of different networks and/or communication links.

Application system 730 includes, for example, one or more online systems that provide social network services, general-purpose search engines, specific-purpose search engines, messaging systems, content distribution platforms, e-commerce software, enterprise software, or any combination of any of the foregoing or other types of software. Application system 730 includes any type of application system that provides or enables the retrieval of and interactions with one or more forms of digital content, including machine-generated content via user interface 712. In some examples, portions of agent system 780 are components of application system 730. In some examples, an application system 730 includes one or more of an entity graph 732 and/or knowledge graph 734, a user connection network 15315, a content distribution service 738, and/or a search engine 740. In other examples, application system 730 interacts with agent system 780 to control a physical machine or device, such as a vehicle or a robot.

In some examples, a front end portion of application system 730 operates in user system 710, for example as a plugin or widget in a graphical user interface of a web application, mobile software application, or as a web browser executing user interface 712. In an example, a mobile app or a web browser of a user system 710 transmits a network communication such as an HTTP request over network 720 in response to user input that is received through a user interface provided by the web application, mobile app, or web browser, such as user interface 712. A server running application system 730 receives the input from the web application, mobile app, or browser executing user interface 712, performs one or more operations using the input, and returns output to the user interface 712 using a network communication such as an HTTP response, which the web application, mobile app, or browser receives and processes at the user system 710.

In the example of FIG. 7, an application system 730 includes an entity graph 732 and/or a knowledge graph 734. Entity graph 732 and/or knowledge graph 734 include data organized according to graph-based data structures that are searchable or traversable via queries and/or indexes to determine relationships between entities. In some examples, entity graph 732 and/or knowledge graph 734 is used to compute various types of relationship weights, affinity scores, similarity measurements, and/or statistics between, among, or relating to entities.

Entity graph 732, knowledge graph 734 includes a graph-based representation of data stored in data storage system 760, described herein. For example, entity graph 732, knowledge graph 734 represents entities, such as users, organizations (e.g., companies, schools, institutions), content items (e.g., job postings, announcements, articles, comments, and shares), and computing resources (e.g., databases, models, applications, and services), as nodes of a graph. Entity graph 732, knowledge graph 734 represents relationships, also referred to as mappings or links, between or among entities as edges, or combinations of edges, between the nodes of the graph. In some examples, mappings between different pieces of data used by an application system 730 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” If a user viewing a list of search results skip over a search result without clicking on the search result, an edge is not created between the user entity and the search result entity in the entity graph, in some examples.

Portions of entity graph 732, knowledge graph 734 are automatically re-generated or updated from time to time based on changes and updates to the stored data, e.g., updates to entity data and/or activity data. In some examples, entity graph 732, knowledge graph 734 refers to an entire system-wide entity graph or to only a portion of a system-wide graph. In some examples, entity graph 732, knowledge graph 734 refers to a subset of a system-wide graph, where the subset pertains to a particular user or group of users of application system 730.

Knowledge graph 734 includes a graph-based representation of data stored in data storage system 760, described herein. Knowledge graph 734 represents relationships, also referred to as links or mappings, between entities or concepts as edges, or combinations of edges, between the nodes of the graph. In some examples, mappings between different pieces of data used by application system 730 or across multiple different application systems are represented by the knowledge graph 734.

In some examples, knowledge graph 734 is a subset or a superset of entity graph 732. In some examples, knowledge graph 734 includes multiple different entity graphs 732 that are joined by cross-application or cross-domain edges. In some examples, knowledge graph 734 joins entity graphs 732 that have been created across multiple different databases or across different software products. In some examples, the entity nodes of the knowledge graph 734 represent concepts, such as product surfaces, verticals, or application domains. In some examples, knowledge graph 734 includes a platform that extracts and stores different concepts that is used to establish links between data across multiple different software applications. Examples of concepts include topics, industries, and skills. As with other portions of entity graph 732, knowledge graph 734 is usable to compute various types of relationship weights, affinity scores, similarity measurements, and/or statistical correlations between or among entities and/or concepts.

In the example of FIG. 7, application system 730 includes a user connection network 736. User connection network 736 includes, for instance, a social network service, professional social network system and/or other social graph-based applications. Content distribution service 738 includes, for example, a feed, chatbot or chat-style system, or a messaging system, such as a peer-to-peer messaging system that enables the creation and exchange of messages between users of application system 730 and the application system 730. Search engine 740 includes a search engine that enables users of application system 730 to input and execute search queries to retrieve information from one or more sources of information, such as user connection network 736, entity graph 732, knowledge graph 734, one or more data stores of data storage system 760, or one or more data resources and tools 750.

In the example of FIG. 7, application system 730 includes a content distribution service 738. The content distribution service 738 includes a data storage service, such as a web server, which stores digital content items, and transmits digital content items to users via user interface 712. In some examples, content distribution service 738 processes requests from, for example, application system 730 and/or agent system 780, and distributes digital content items to user systems 710 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 738 is part of application system 730. In other examples, content distribution service 738 interfaces with application system 730 and/or agent system 780, for example, via one or more application programming interfaces (APIs).

In the example of FIG. 7, application system 730 includes a search engine 740. Search engine 740 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 740 is used to retrieve data in response to user input and/or system-generated queries, by executing queries on various data stores of data storage system 760 and/or data resources and tools 750, or by traversing entity graph 732, knowledge graph 734.

Data resources and tools 750 include computing resources, such as data stores, databases, embedding-based retrieval mechanisms, code generators, etc., that are capable of being used to operate an agent or agent system. Data resources and tools 750 include computing resources that are internal to application system 730 or external to application system 730. Examples of data resources and tools 750 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 750 enables an agent or agent system to access the data resource or tool, for example by providing an application programming interface (API). Each data resource or tool 750 includes a monitoring service that periodically generates, publishes, or broadcasts availability and/or other performance metrics associated with the data resource, in some examples. A data resource or tool 750 provides a set of APIs that are used by an agent or agent system to access the data resource or tool, obtain output from the data resource, and/or obtain performance metrics for the data resource or tool, in some examples.

Data storage system 760 includes data stores and/or data services that store digital data received, used, manipulated, and produced by application system 730 and/or agent system 780, including contextual data, state data, prompts and/or prompt templates for generative artificial intelligence models or large language models, user inputs, system-generated outputs, metadata, attribute data, activity data. Databases or data stores that are capable of being used in some of the described examples include but are not limited to vector databases, graph databases, relational databases, and key-value stores.

In the example of FIG. 7, data storage system 760 includes various data stores that store, for example, entity data, context data, prompts, embeddings, etc. A data store includes include a volatile memory such as a form of random access memory (RAM) and/or persistent memory, which can be available on user system 710 or another device (e.g., one or more servers) for storing state data generated at the user system 710 or an application system 730. In some examples, a separate, personalized version of each or any data store is created for each user such that data is not shared between or among the separate, personalized versions of the data stores.

In some examples, data storage system 760 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. Data stores of data storage system 760 are capable of storing data produced by real-time and/or offline (e.g., batch) data processing. A data store configured for real-time data processing is referred to as a real-time data store, in some examples. A data store configured for offline or batch data processing is referred to as an offline data store, in some examples. Data stores are capable of being implemented using databases, such as key-value stores, relational databases, and/or graph databases. Data is written to and read from data stores using query technologies, e.g., SQL or NoSQL.

Data storage system 760 resides on one or more persistent and/or volatile storage devices that reside within the same local network as other devices of computing system 700 and/or in a network that is remote relative to other devices of computing system 700. Thus, although depicted as being included in computing system 700, portions of data storage system 760 are part of computing system 700 or accessed by computing system 700 over a network, such as network 720, in some examples.

Event logging service 770 captures and records activity data generated during operation of application system 730 and/or agent system 780, including user interface events generated at user systems 710 via user interface 712, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, when a user of application system 730 via a user system 710 enters input or clicks on a user interface element, such as a workflow element, or a user interface control element such as a view, comment, share, or reaction button, or uploads a file, or inputs a query, or scrolls through a feed, etc., event logging service 770 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to system-generated output, such as a list of search results, event logging service 770 stores the corresponding event data in a log. Event logging service 770 generates a data stream that includes a record of real-time event data for each user interface event that has occurred. Event data logged by event logging service 770 is pre-processed and anonymized as needed so that it is capable of being used as context data to, for example, configure one or more instructions for one or more artificial intelligence models (e.g., large language models), or to modify weights, affinity scores, or similarity measurements that are assigned by the agent system to search results or data resources.

Agent system 780 includes any one or more of the components, features, or functions described herein with respect to an agent system or search application. For example, agent system 780 includes components of a multi-agent system as described herein.

AI model service 790 includes one or more artificial intelligence-based models, such as large language models and/or other types of machine learning models including discriminative and/or generative models, neural networks, probabilistic models, statistical models, transformer-based models, and/or any combination of any of the foregoing. AI model service 790 enables automated agents and agent systems to access to these models, for example by providing one or more application programming interfaces (APIs). AI model service 790 includes a monitoring service that periodically generates, publishes, or broadcasts latency and/or other performance metrics associated with the models. In some examples, AI model service 790 provides a set of APIs that are used by an agent or agent system to obtain performance metrics for large language models and/or other machine learning models.

While not specifically shown, it should be understood that any of user system 710, application system 730, data resources and tools 750, data storage system 760, event logging service 770, agent system 780, and AI model service 790 includes an interface embodied as computer programming code stored in computer memory that when executed causes a computing device to enable bidirectional communication with any other of user system 710, application system 730, data resources and tools 750, data storage system 760, event logging service 770, agent system 780, and AI model service 790 using a communicative coupling mechanism. Examples of communicative coupling mechanisms include network interfaces, inter-process communication (IPC) interfaces and application program interfaces (APIs).

Each of user system 710, application system 730, data resources and tools 750, data storage system 760, event logging service 770, agent system 780, and AI model service 790 is implemented using one or more computing devices that are communicatively coupled to electronic communications network 720. Any of user system 710, application system 730, data resources and tools 750, data storage system 760, event logging service 770, agent system 780, and AI model service 790 are capable of being bidirectionally communicatively coupled by network 720. User system 710 as well as other different user systems (not shown) are bidirectionally communicatively coupled to application system 730 and/or agent system 780, in some examples.

Examples of users of user system 710 include an administrator or end user of application system 730 or agent system 780. User system 710 is configured to communicate bidirectionally with any of application system 730, data resources and tools 750, data storage system 760, event logging service 770, agent system 780, and AI model service 790 over network 720.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 710, application system 730, data resources and tools 750, data storage system 760, event logging service 770, agent system 780, and AI model service 790 are implemented using computer software, hardware, or software and hardware, and include combinations of automated functionality, data structures, and digital data, which are represented schematically in the figures. User system 710, application system 730, data resources and tools 750, data storage system 760, event logging service 770, agent system 780, and AI model service 790 are shown as separate elements in FIG. 15 for ease of discussion but, except as otherwise described, the illustration is not meant to imply that separation of these elements is required. The illustrated systems, services, and data stores (or their functionality) of each of user system 710, application system 730, data resources and tools 750, data storage system 760, event logging service 770, agent system 780, and AI model service 790 are capable of being divided over any number of physical systems, including a single physical computer system, and are capable of communicating with each other in any appropriate manner.

In the example of FIG. 9, portions of agent system 780 that are capable of being implemented on a front end system, such as one or more user systems, and portions of agent system 780 that are capable of being implemented on a back end system such as one or more servers, are collectively represented as agent system 950 for ease of discussion only. In some examples, portions of agent system 780 are not required to be implemented all on the same computing device, in the same memory, or loaded into the same memory at the same time. In some examples, access to portions of agent system 780 is limited to different, mutually exclusive sets of user systems and/or servers. In some examples, a separate, personalized version of agent system 780 is created for each user of the agent system 780 such that data is not shared between or among the separate, personalized versions of the agent system 780. Certain portions of agent system 780 are capable of being implemented on user systems while other portions of agent system 780 are capable of being implemented on a server computer or group of servers. In some examples, one or more portions of agent system 780 are implemented on user systems. Agent system 780 is entirely implemented on user systems, e.g., client devices, in some examples. In some examples, a version of agent system 780 is embedded in a client device's operating system or stored at the client device and loaded into memory at execution time.

The examples shown in FIG. 7 and the accompanying description, above are provided for illustration purposes. This disclosure is not limited to the described examples.

FIG. 8A, FIG. 8B, FIG. 8C, and FIG. 8D are block diagrams of examples of machine learning models that are usable by and/or included in an input augmentation system in accordance with some examples of the present disclosure.

Machine learning models are computer-implemented structures that are capable of generating predictive output in response to raw input. A machine learning model includes a probabilistic or statistical algorithm that is configured to perform a specific predictive function through a training process that involves iteratively exposing the models to many samples of data and adjusting one or more model parameters until the models achieve a satisfactory prediction accuracy and reliability. The predictive accuracy and reliability of a machine learning model in relation to a particular task is dependent upon the training process and the data used in the training.

Machine learning systems include components and processes that perform data generation, model training, model evaluation (e.g., calibration and validation), and application. Data preparation includes obtaining and aggregating model input data. The preparation of training data includes labeling the aggregated data, in some examples. Training data includes structured data, unstructured data, text, multimodal data, or any combination of any of the foregoing. Model training includes setting values of hyperparameters, determining performance metrics, adjusting weights of the machine learning model in response to the training data, evaluating the performance metrics, and parameter tuning. Application includes applying the trained machine learning model to the real-world environment, e.g., in a specific use case using data not included in the training data (e.g., unlabeled data). The application phase is referred to as inferencing or inference time, in some examples.

In FIG. 8A, a machine learning modeling system 800 includes a machine learning model 806, a modeling and calibration subsystem 802, and a model validation subsystem 804. The machine learning model 806 is any type or combination of one or more machine learning models, such as any of the types of machine learning models shown in FIG. 8B, FIG. 8C, and FIG. 8D and/or any other types or combinations of machine learning models.

The modeling and calibration subsystem 802 receives model input, such as input feature sets, embeddings, digital content, or prompts. The model input is engineered to train the machine learning model 806 to perform one or more tasks, such as discriminative tasks like classification or scoring and/or generative tasks such as content generation tasks. Modeling and calibration subsystem 802 includes a data set creation component 803, a model training component 805, and a model calibration component 807.

Data set creation component 803 divides the model input, e.g., input feature sets, into one or more training data sets and one or more validation data sets, e.g., training data set 809 and validation data set 811. Model training component 805 and model calibration component 807 cooperatively execute a training process. In some examples, the training process causes the machine learning model 806 to develop, by iterative adjustments to weights or coefficients, a mathematical representation of the relationships between different items of data, such as relationships between different inputs (e.g., similarity estimates or estimates of user preferences), or relationships between inputs and categorical data such as classification labels, or relationships between inputs and outputs. The resulting trained model is used to generate predictive output (e.g., scores, labels, or other output) based on subsequent model input.

One or more different approaches are used to train the machine learning model 806, for example, supervised machine learning, semi-supervised machine learning, or unsupervised machine learning. In supervised machine learning, the set of training data includes indications of expected model output coupled with respective model input; for example, ground-truth labeled data samples. In some examples, an instance of training data for supervised learning includes a model input (e.g., a set of features) and an associated expected output (e.g., a classification label), where the expected output is human curated or machine-generated. In some examples, an instance of training data for supervised machine learning includes a digital image and a title or caption for the image that describes the contents of the image. In unsupervised machine learning, the training examples are unlabeled. In unsupervised machine learning, a machine learning algorithm such as a clustering algorithm is used to identify similarities among data samples and create clusters or groupings of similar data using one or more similarity criteria. In some examples, unsupervised learning is used to group digital content items, such as images, articles, or videos, into topics, where the topics are determined based on the features of the content items themselves rather than supplied by labels. Semi-supervised machine learning combines supervised and unsupervised machine learning, using both labeled and unlabeled data to train machine learning models.

Model training component 805 applies machine learning model 806 to training data set 809 iteratively and adjusts the value of one or more model parameters and/or feature coefficients of the machine learning model 806 based on the processing of the training data set 809 by the model 806 until the difference between the predicted model output generated by the machine learning model 806 and the expected model output evidenced by the training data set 809 satisfies (e.g., meets or exceeds) model performance criteria 808. When the model performance criteria 808 are satisfied, modeling and calibration subsystem 802 ends the model training process and produces a trained machine learning model 806.

Model validation subsystem 804 applies a model validation process to the trained machine learning model 806 produced by modeling and calibration subsystem 802. Model validation subsystem 804 uses the validation data set 811 to determine whether model validation criteria 810 are satisfied (e.g., met or exceeded). In some examples, the validation data set 811 is created by setting aside a portion of the training data set 809 until after training, such that the validation data set 811 is used to compare and evaluate the difference between the predictive output produced by the trained model to the expected model output evidenced by the set-aside portion of the training data set 809.

A validated machine learning model 806 is used for inferencing, e.g., to generate predictive output, e.g., labels, scores, or other content, in response to model input. Alternatively or in addition, the output produced by the validated machine learning model 806 is stored for future use (e.g., for access or lookup by one or more downstream processes, systems, or services).

There are many different types and configurations of machine learning models. Illustrative, nonlimiting examples of some of the different types of machine learning models are shown in FIG. 8B, FIG. 8C, and FIG. 8D, described below. The AIs, models, and AI model services described herein are capable of including or using any of the various types of machine learning models, including but not limited to one or more of the types of models shown in FIG. 8B, FIG. 8C, and FIG. 8D.

The examples shown in FIG. 8A and the accompanying description, above are provided for illustration purposes. This disclosure is not limited to the described examples.

FIG. 8B is a block diagram of a machine learning model that is capable of being used by and/or included in an agent system in accordance with some examples of the present disclosure.

A generative machine learning model (GMLM) or generative model uses artificial intelligence technology, e.g., machine learning, neural networks, to machine-generate digital content based on model inputs and the previously existing data with which the model has been trained. Whereas discriminative models are based on conditional probabilities P(y|x), that is, the probability of an output y given an input x, generative models capture joint probabilities P (x, y), that is, the likelihood of x and y occurring together. A generative language model is a particular type of GMLM that is capable of generating content in response to model input. The model input includes a task description, also referred to as a prompt. The task description includes instructions (e.g., natural language instructions such as “please generate a summary of these search results”) and/or examples of digital content (e.g., examples of summaries written using a particular writing style or tone). Portions of the task description are in the form of natural language text, such as a question or a statement, in some examples. Alternatively or in addition, a task description or prompt includes non-text forms of content, such as digital imagery and/or digital audio.

In the example of FIG. 8B, a machine learning system 820 includes a machine learning model 824. Machine learning model 824 is or includes a probabilistic or statistical machine learning model that uses a modeling function to model the likelihood of cooccurrence of input feature set X and output Y; e.g., the likelihood of X and Y occurring together. The machine learning model 824 is configured via training, calibration, and validation processes such as those described with reference to FIG. 8A. Some examples of the machine learning model 824 are alternatively or additionally configured as a discriminative model. In some examples, a machine learning model performs both discriminative and generative tasks.

The machine learning model 824 includes a modeling function 825. The modeling function 825 includes feature coefficients or weights 826. The values of one or more of the feature coefficients is established via machine learning model training, calibration, and validation processes based on training data sets and/or validation data sets. The machine learning model 824 also includes model hyperparameters 827. The values of model hyperparameters 827 are selected or tuned at a global level and generally are not modified based on specific instances of training data.

The model input 822 (e.g., input feature set X) includes numerical features, categorical features, quantitative values, qualitative values, raw features, compressed representations of raw features (e.g., vector representations or embeddings), and/or other forms of digital content.

In response to an instance of model input 822 (e.g., instance of feature set X), machine learning model 824 computes and outputs an estimated output P (X,Y) 828. The estimated output produced by machine learning model 824 based on a model input 822 is in the form of an input-output pair and a score or simply includes the highest scoring input-output pair. In some examples, the output is stored in a data storage for subsequent lookup or provided to one or more downstream systems, processes, devices, frameworks, and/or services.

The machine learning model 824 is configured and implemented as a network service, in some examples. The machine learning model 824 is configured using a machine learning library and an application programming interface (API), e.g., via an API call such as ML_library.model(p1, p2, . . . pn), where p indicates a parameter or argument of the call, such as a model hyperparameter or an input feature set identifier, in some examples. Once configured, the machine learning model 824 and/or its output are hosted on one or more servers and/or data storage devices for accessibility to one or more requesting processes, systems, devices, frameworks, or services.

The examples shown in FIG. 8B and the accompanying description, above are provided for illustration purposes. This disclosure is not limited to the described examples.

FIG. 8C is a block diagram of a machine learning model that is capable of being used by and/or included in an agent system in accordance with some examples of the present disclosure.

A specific example of a machine learning model is a deep neural network. Some machine learning models, such as multi-task models, include multiple interconnected deep neural networks. In the example of FIG. 8C, a machine learning system 830 includes a deep neural network 834. The deep neural network 834 is configured via training, calibration, and validation processes such as those described with reference to FIG. 8A. Some examples of the deep neural network 834 are configured as a discriminative model and/or a generative model. In some examples, a deep neural network 834 performs both discriminative and generative tasks.

In computer science, deep learning refers to a class of machine learning that uses computer-implemented neural networks to generate predictive output, where the neural networks have one or more internal (or hidden) layers between and in addition to an input layer and an output layer. Each layer in a deep neural network (or deep learning model) performs a set of computational operations on the input to that layer.

Each layer of the neural network includes a set of nodes that each apply an activation function to one or more portions of the input to that layer to produce an output. The activation function performs a nonlinear transformation of the input and sends its output to the next layer of the network. For example, if the output of the activation function is equal to or exceeds a threshold value, the node passes its output to the next layer, but if the output is less than the threshold value, the output passed to the next layer is zero or a null value. The type of activation function used at a node or layer is selected based on the particular predictive task for which the model is configured and/or based on the model architecture. Examples of activation functions include the SoftMax function (for multi-class classification), the sigmoid function (for internal layers), and rectifier functions (e.g., ramp, or Rectified Linear Unit (ReLU)).

The input layer of a deep neural network receives and processes the model input, which includes raw data and/or pre-processed data such as aggregations, derivations, embeddings or vector representations of raw data. In some examples, the output of a layer of the neural network is connected to and used as the input to one or more other layers, such that each layer of the deep learning model creates a different (e.g., progressively more highly processed) set of information relating to the original, raw input (e.g., producing a different representation of the raw input at each layer). Weights are applied to the output of each node of each layer before the output is propagated to the next layer. The weight values are adjusted so that the outputs of some nodes or layers influences the final output more or less than the outputs of other nodes or layers, in some examples. The output layer of the neural network produces the final predictive output, which is made accessible to one or more downstream models, applications, systems, operations, processes or services.

Backpropagation is an example of a method that is often used to train a neural network model. In a feedforward step, the training data is propagated from the input layer through the internal layers to the final output by computing each successive layer's outputs up to and including the final output. A loss function (or cost function, such as cross-entropy, log loss, or squared error loss, or a logistic function) is used to compute error for the final output, for example, based on a comparison of the difference between the output predicted by the model and the expected or target output to the error computed on a previous iteration. The model weights (or parameters or coefficients) are adjusted to reduce the error, iteratively, until the error falls within an acceptable range or the error stops changing by more than a threshold amount (e.g., the model converges). In backpropagation, these iterative weight adjustments are propagated backward from the output layer through the internal layers. The gradient of the loss function or gradient descent (e.g., stochastic gradient descent) is often used in backpropagation.

In some examples, recommendation systems use deep learning models to generate predictive output and use the predictive output to configure or control one or more downstream operations. In some examples, recommendation systems compute statistical or probabilistic predictions that are used to select, rank, or sort digital content items for presentation to users via electronic devices. Examples of downstream operations that are capable of using the predictive output of deep learning recommendation systems include news feeds, automated product recommendations, and automated connection (e.g., friend, follower, or contact) recommendations for online platforms such as social networks. Other examples include systems that support human decision making, such as systems that use artificial intelligence to generate recommendations for health care, financial services, training, education, and/or other fields or topics. Still other examples include control systems that use artificial intelligence to recommend courses of action to other components of automated systems in operational environments, such as “smart” vehicles, appliances, robots, and other automated devices.

In the example of FIG. 8C, the deep neural network 834 includes an input layer 835, one or more hidden layers 836, and an output layer 837. The input layer 835 receives one or more batches of model input 823 (e.g., input feature sets X). In some examples, the input layer 835 includes a number of nodes that corresponds to the number of input features in a given input feature set X. The output of the input layer 835 becomes the input to the one or more hidden layers 836. The output of the one or more hidden layers 836 becomes the input to the output layer 837. The output layer 837 outputs the final predictive output 838. In some examples, each of the layers of the deep neural network 834 is fully connected in the sense that the output of each node of each layer is connected to the input of each node of the next subsequent layer. In other examples, the deep neural network 834 includes portions that are not fully connected.

The deep neural network 834 is capable of being configured and implemented as a network service. In some examples, the deep neural network 834 is configured using a machine learning library and an application programming interface (API), e.g., via an API call such as ML_library.model (p1, p2, . . . pn), where p indicates a parameter or argument of the call, such as a model hyperparameter or an input feature set identifier. Once configured, the deep neural network 834 and/or its output are hosted on one or more servers and/or data storage devices for accessibility to one or more requesting processes, systems, devices, frameworks, or services.

The input feature set X includes numerical features, categorical features, quantitative values, qualitative values, raw features, compressed representations of raw features (e.g., vector representations or embeddings), natural language, and/or other forms of digital content. Embedding refers to a numerical representation of a set of features, in some examples. An embedding encodes information, e.g., a set of features associated with an entity and/or attribute, relative to an embedding space. Embeddings and embedding spaces are generated by artificial intelligence (AI) models. An embedding is often expressed as a vector, where each dimension of the vector includes a numerical value that is an integer or a real number (e.g., a floating point value). The numerical value assigned to a given dimension of the vector conveys information about the data represented by the embedding, relative to the embedding space, also referred to as a vector space. The embedding space (or vector space) includes all of the possible values of each dimension of the vector. The embedding space is defined by the way in which the AI model used to generate the vector has been trained and configured, including the training data used to train the AI model. In some examples, train as used herein refers to an iterative process of applying an AI algorithm to one or more sets of training data, analyzing the output of the AI model in comparison to expected model output using a loss function (also referred to as a cost function or error function), adjusting values of one or more parameters and/or coefficients of the AI model, and repeating the process until the difference between the actual model output and the expected model output falls within an acceptable range of error or tolerance.

Embedding-based retrieval (EBR) is a method of searching for similar digital content, such as documents or portions of documents. Embedding-based retrieval involves converting digital data, e.g., sets of features, to embeddings and then using a similarity algorithm, such as nearest-neighbor search or cosine similarity, to identify embeddings that are similar to one another. Match or map refers to an exact match or an inexact match, in various examples. Match or map refers to a machine-determined predicted or estimated degree of relevance, similarity or compatibility between entities or data items that satisfies (e.g., meets or exceeds) a threshold level of relevance, similarity or compatibility, where the threshold level of relevance, similarity or compatibility is variable based on the requirements of a particular design or implementation. The threshold level of relevance, similarity, or compatibility is set lower or higher for different types of matching or mapping, in some examples.

In response to an instance of feature set X, deep neural network 834 computes and outputs a predictive output 838. The predictive output 838 is stored in a data storage for subsequent lookup or provided to one or more downstream systems, processes, devices, frameworks, and/or services.

The deep neural network 834 is configured and implemented as a network service, in some examples. The deep neural network 834 is configured using a machine learning library and an application programming interface (API), e.g., via an API call such as ML_library.model (p1, p2, . . . pn), where p indicates a parameter or argument of the call, such as a model hyperparameter or an input feature set identifier, in some examples. Once configured, the machine learning model 806 and/or its output are hosted on one or more servers and/or data storage devices for accessibility to one or more requesting processes, systems, devices, frameworks, or services.

The examples shown in FIG. 8C and the accompanying description, above are provided for illustration purposes. This disclosure is not limited to the described examples.

FIG. 8D is a block diagram of a machine learning model that is capable of being used by and/or included in an agent system in accordance with some examples of the present disclosure.

A specific example of a deep neural network is a sequence to sequence model, which takes sequential data such as words, phrases, or images (sequences of characters, tokens, or pixel values) or time series data as input and outputs sequential data. An example of a sequence to sequence model is an encoder-decoder model. In an encoder-decoder model, a first neural network known as an encoder transforms the model input into an encoded version of the model input, e.g., an embedding or vector. In some examples, an encoder transforms a sentence or an image into a sequence of numbers. A second neural network known as the decoder takes the output of the encoder (e.g., the encoded version of the model input) and decodes it. In some examples, a decoder transforms the sequence of numbers created and output by the encoder into a translated sentence or another form of output.

A specific example of an encode-decoder model is a transformer model. A transformer model is a deep neural network encoder-decoder model that uses a technique called attention or self-attention to detect relationships and dependencies among data elements in a sequence. Transformer models are capable of being used to perform various natural language processing (NLP) tasks and other machine learning tasks, such as generating content based on input attributes or tokens. In some examples, the attention mechanism facilitates the detection of relationships and dependencies between words and phrases.

In the example of FIG. 8D, a machine learning system 840 includes a transformer model 842. The transformer model 842 is constructed using a neural network-based machine learning model architecture. In some examples, the neural network-based architecture includes one or more self-attention layers (e.g., multi-head attention layer 845, masked multi-head attention layer 855, and multi-head attention layer 857) that allow the model to assign different weights to different features included in the model input. Alternatively, or in addition, the neural network architecture includes feed-forward layers (e.g., feed-forward layer 847 and feed-forward layer 859) and residual connections (e.g., add & norm layer 846, add & norm layer 848, add & norm layer 856, add & norm layer 858, add & norm layer 860) that allow the model to machine-learn complex data patterns including relationships between different states, actions, and rewards in multiple different contexts. In some examples, transformer model 842 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the user trajectory processing system.

As shown in FIG. 8D, transformer model 842 feeds embedded subsequences 850 into encoder 844 and decoder 854. For example, transformer model 842 feeds inputs of embedded subsequences 850 into multi-head attention layer 845 of encoder 844. In some examples, inputs of embedded subsequences 850 are a series of tokens and the output of the encoder (e.g., encoder output representation 852), is a fixed-dimensional representation for each of the tokens of embedded subsequences 850 including an embedding for inputs of embedded subsequences 850. Transformer model 842 feeds encoder output representation 852 and outputs of embedded subsequences 850 into decoder 854 which generates a sequence of tokens based on encoder output representation 852 and the input embeddings. While a specific architecture of encoder 844 and decoder 854 is shown for simplicity, as explained above, the exact number and arrangement of layers of each type as well as the hyperparameter values used to configure the model are determined based on the requirements of a particular design or implementation. Therefore, in some examples, transformer model 842 includes different numbers, arrangements, and types of layers, such that each input token of embedded subsequences 850 is fed through the layers of transformer model 842 and is dependent on other input tokens of embedded subsequences 850.

Transformer model 842 illustrates a generic encoder/decoder model for simplicity. In such a model, encoder 844 encodes the input into a fixed-length vector (e.g., encoder output representation 852) and decoder 854 decodes the fixed-length vector into an output sequence. Encoder 844 and decoder 854 are trained together to maximize the conditional log-likelihood of the output given the input. Once trained, encoder 844 and decoder 854 are capable of generating output given an input sequence or scoring a pair of input-output sequences based on their probability of coexistence.

As shown in FIG. 8D, encoder 844 includes multi-head attention layer 845, add & norm layer 846, feed-forward layer 847, and add & norm layer 848. Multi-head attention layer 845 receives inputs of embedded subsequences 850 and computes output representations for each of the input tokens of embedded subsequences 850 based on the inputs of embedded subsequences 850. For example, multi-head attention layer 845 converts each input token of embedded subsequences 850 into queries, keys, and values using query, key, and value matrices. Multi-head attention layer 845 computes the output representation of the input tokens of embedded subsequences 850 as the weighted sum of the values of all of the input tokens of embedded subsequences 850. Multi-head attention layer 845 computes the weights for the weighted sum by applying a compatibility function to the corresponding key and query for the value. For example, multi-head attention layer 845 uses a scaled dot product on the key and query of an input token to determine a weight to apply to a value of the input token. Multi-head attention layer 845 includes multiple attention blocks which each compute an output representation for the input token. Multi-head attention layer 845 aggregates the output representations of these attention blocks to generate a final output representation for multi-head attention layer 845.

Transformer model 842 feeds the output representation generated by multi-head attention layer 845 and residual connections from the inputs of embedded subsequences 850 into add & norm layer 846. By including these residual connections, transformer model 842 ensures that it does not “forget” features of embedded subsequences 850 during training. Forgetting in the context of machine learning refers to a phenomenon that occurs as the model continues to be sequentially trained on different datasets over time. Because the model continually adjusts the values of feature coefficients as it is trained on subsequent training datasets, these continuous adjustments of the feature coefficient values is capable of causing the influence of the datasets used earlier in training on those coefficient values to be lost or diluted.

Add & norm layer 846 sums the output representation generated by multi-head attention layer 845 and the residual connections from inputs of embedded subsequences 850 and applies a layer normalization to the result. In some examples, the add & normal layers also apply a SoftMax function to generate action probabilities for the inputs of embedded subsequences 850. For example, add & norm layer 846 generates estimated probabilities \hat{p}(aₖ|s), where aₖ is the action policy and s is the state features.

Transformer model 842 feeds the normalized output of add & norm layer 846 into feed-forward layer 847. Feed-forward layer 847 is a feed-forward network that receives the normalized output, feeds it through the hidden layers of feed-forward layer 847, and then feeds the output of feed-forward layer 847 into add & norm layer 848. Feed-forward layer 847 processes the information received from add & norm layer 846 and updates the hidden layers of feed-forward layer 847 based on the information (e.g., during training) and/or generate an output based on the hidden layers processing the information (e.g., during evaluation and/or inference). For example, during training, transformer model 842 updates the weights of the hidden layers of feed-forward layer 847 based on the inputs and the loss of the transformer system. Further details with regard to the loss of the transformer system as well as training objectives and metrics are discussed below. As an alternative example, during evaluation and/or inference, the weights of the hidden layers of feed-forward layer 847 are used to determine the output representation 852 of each of the input tokens of embedded subsequences 850.

Transformer model 842 feeds the output of feed-forward layer 847 into add & norm layer 848 as well as residual connections from the output of add & norm layer 846. Add & norm layer 848 sums the output of feed-forward layer 847 with the residual connections from add & norm layer 846 and applies a layer normalization to the result to generate encoder output representation 852. Transformer model 842 feeds encoder output representation 852 into multi-head attention layer 857 of decoder 854 as explained below.

Masked multi-head attention layer 855 receives outputs of embedded subsequences 850 and computes representations for each of the output tokens of embedded subsequences 850 based on masked outputs of embedded subsequences 850. For example, masked multi-head attention layer 855 computes representations for each of the output tokens of embedded subsequences 850 based on previous output tokens while masking future output tokens. Masked multi-head attention layer 855 therefore only computes representations using tokens that come before the token masked multi-head attention layer 855 is trying to predict.

Transformer model 842 feeds the representation generated by masked multi-head attention layer 855 and residual connections from the outputs of embedded subsequences 850 into add & norm layer 856. Add & norm layer 856 sums the representation generated by masked multi-head attention layer 855 and the residual connections from outputs of embedded subsequences 850 and applies a layer normalization to the result.

Transformer model 842 feeds the normalized output of add & norm layer 856 into multi-head attention layer 857. Multi-head attention layer 857 receives the normalized output of add & norm layer 856 as well as encoder output representation 852 from encoder 844 and generates a representation based on both.

Transformer model 842 feeds the representation generated by multi-head attention layer 857 and residual connections from the output of add & norm layer 856 into add & norm layer 858. Add & norm layer 858 sums the representation generated by multi-head attention layer 857 and the residual connections from the output of add & norm layer 856 and applies a layer normalization to the result.

Transformer model 842 feeds the normalized output of add & norm layer 858 into feed-forward layer 859. Feed-forward layer 859 is a feed-forward network that receives the normalized output, feeds it through the hidden layers of feed-forward layer 859, and then feeds the output of feed-forward layer 859 into add & norm layer 869. Feed-forward layer 859 processes the information received from add & norm layer 858 and updates the hidden layers of feed-forward layer 859 based on the information (e.g., during training) and/or generate an output based on the hidden layers processing the information (e.g., during evaluation and/or inference). For example, during training, transformer model 842 updates the weights of the hidden layers of feed-forward layer 859 based on the inputs and the loss of the transformer system. Further details with regard to the loss of the transformer system as well as training objectives and metrics are discussed below. As an alternative example, during evaluation and/or inference, the weights of the hidden layers of feed-forward layer 859 are used to determine the output of feed-forward layer 859.

Transformer model 842 feeds the output of feed-forward layer 859 into add & norm layer 860 as well as residual connections from the output of add & norm layer 858. Add & norm layer 860 sums the output of feed-forward layer 859 with the residual connections from add & norm layer 858 and applies a layer normalization to the result to generate an output.

Transformer model 842 generates output probabilities 862 from the output of add & norm layer 860. For example, transformer model 842 applies a linear transformation and a SoftMax function to the output of add & norm layer 860 to generate a normalized vector of output probabilities 862.

In some examples, such as during training, transformer model 842 determines a loss for the system based on output probabilities 862. In some examples, transformer model 842 uses deep quantile regression for training. In such an example, output probabilities 862 includes a mean prediction probability and estimations for the upper and lower bounds of the range of prediction such that output probabilities 626 includes an uncertainty range. In one example, the loss function of transformer model 842 using deep quantile regression is represented by the following equation:

$$ℒ ( {ξ}_{i} \vert α ) = \{ \begin{matrix}{αξ}_{i} if {ξ}_{i} \geq 0 \\ ( α - 1 ) {ξ}_{i} if {ξ}_{i} < 0\end{matrix} ,$$

where α is the required quantile (a value between 0 and 1 representing the desired quantile) and ξᵢ=yᵢ−f(xᵢ), where f(xᵢ) is the mean predicted by output probabilities 862, yᵢ are the outputs of embedded subsequences 850 and xᵢ are the inputs of embedded subsequences 850. The loss over the entirety of a dataset of embedded subsequences 850 where embedded subsequences 850 has a length of N is capable of being represented by the following equation:

$$ℒ ( y , f \vert α ) = \frac{1}{N} {\sum }_{i = 1}^{N} ℒ ( {y}_{i} - f ( {x}_{i} ) \vert α ) .$$

In such examples, output probabilities 862 includes three values: a mean prediction, a lower bound quantile, and an upper bound quantile. In some examples, transformer model 842 uses upper confidence bound or Thompson sampling. In some examples, transformer model 842 determines model output 864 based on the mean prediction, the lower bound quantile, and the upper bound quantile based on upper confidence bound and/or Thompson sampling.

In some examples, transformer model 842 is trained to optimize the model parameters with trajectory-specific normalizations using cross-entropy loss. For example, transformer model 842 uses a loss function represented by the following equation:

$$L ( θ ) = \frac{1}{{N}_{traj}} {\sum }_{i}^{{N}_{traj}} {\sum }_{t = 1}^{{T}_{i}} {w}_{i} {\sum }_{k} log ( \hat{p} ( {a}_{k}^{( it )} \vert {s}^{( it )} ) ) ,$$

where Nₜᵣₐⱼ is the trajectory count, wᵢ is the normalization weight, aₖ^{(it)} is the predicted action for the trajectory i at timestep t, and s^{(it)} is the state of the online system for the trajectory i at timestep t. In some examples, transformer model 842 uses trajectory-wise normalization. In some examples, the add & norm layers of transformer model 842 normalize the weights according to the following equation:

$${w}_{i} = \frac{1}{{T}_{i}} ,$$

where Tᵢ is the length of trajectory i. In some examples, transformer model 842 uses global normalization. In some examples, the add & norm layers of transformer model 842 normalize the weights according to the following equation: wᵢ=c, where c is a positive scalar. In some examples, the scalar c is predetermined.

Language models, including large language models and other generative models, are capable of being implemented using transformer models. A generative model is commonly constructed using a neural network-based machine learning model architecture. In some examples, the neural network-based architecture includes one or more input layers that receive task descriptions (or prompts), generate one or more embeddings based on the task descriptions, and pass the one or more embeddings to one or more other layers of the neural network. In other examples, the one or more embeddings are generated based on the task description by a pre-processor, the embeddings are input to the generative language model, and the generative language model outputs digital content, e.g., natural language text or a combination of natural language text and non-text output, based on the embeddings.

The neural network-based machine learning model architecture of the generative model often includes one or more self-attention layers that allow the model to assign different weights to different portions of the model input (e.g., different words or phrases included in the model input). Alternatively or in addition, the neural network architecture includes feed-forward layers and residual connections that allow the model to machine-learn complex data patterns including relationships between different words or phrases in multiple different contexts. The language model or other type of generative model is capable of being constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation.

In some examples, the neural network-based machine learning model architecture of a generative model includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models that significantly advance the state-of-the-art in various linguistic tasks such as machine translation, sentiment analysis, question answering and sentence similarity. In some examples, the neural network-based machine learning model architecture includes or is based on one or more predictive content neural models that receive digital content input and generate one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

A generative language model is capable of being trained on a large dataset of natural language text. In some examples, training samples of natural language text extracted from publicly available data sources are used to train a generative language model. The size and composition of the dataset used to train the generative language model are variable according to the requirements of a particular design or implementation. In some examples, the dataset used to train the generative language model includes hundreds of thousands to millions or more different natural language text training samples. In some examples, a generative language model includes multiple generative language models trained on differently sized datasets. In some examples, a generative language model includes a comprehensive but low capacity model that is trained on a large data set and used for generating examples. The same generative language model also includes a less comprehensive but high capacity model that is trained on a smaller data set, such that the high capacity model is used to generate outputs based on data obtained from the low capacity model. In some examples, reinforcement learning is used to further improve the output of the generative language model. In reinforcement learning, ground-truth examples of desired model output are paired with respective prompts, and these prompt-output pairs are used to train or fine tune the generative language model.

Prompt engineering is a technique used to optimize the structure and/or content of a prompt input to a generative model. Some prompts include examples of outputs to be generated by the generative model (e.g., few-shot prompts), while other prompts include no examples of outputs to be generated by the generative model (e.g., zero-shot prompts). Chain of thought prompting is a prompt engineering technique where the prompt includes a request that the model explain reasoning in the output. For example, the generative model performs the task described in the prompt using a series of steps and outputs reasoning as to each step performed.

Supervised learning is a method of training (or fine-tuning) a machine learning model given input-output pairs, where the output of the input-output pair is known (e.g., an expected output, a labeled output, a ground truth). Other training methods including semi-supervised learning or federated learning are capable of being used to train a machine learning model or to fine-tune a pretrained machine learning model.

The transformer model 842 is configured and implemented as a network service, in some examples. The transformer model 842 is configured using a machine learning library and an application programming interface (API), e.g., via an API call such as ML_library.model(p1, p2, . . . pn), where p indicates a parameter or argument of the call, such as a model hyperparameter or an input identifier. Once configured, the transformer model 842 and/or its output are hosted on one or more servers and/or data storage devices for accessibility to one or more requesting processes, systems, devices, frameworks, or services.

The examples shown in FIG. 8D and the accompanying description, above are provided for illustration purposes. This disclosure is not limited to the described examples.

FIG. 9 is a block diagram of an example computer system including components of an input augmentation system in accordance with some examples of the present disclosure.

In FIG. 9, an example machine of a computer system 900 is shown, within which a set of instructions for causing the machine to perform any of the methodologies discussed herein are capable of being executed. In some examples, the computer system 900 corresponds to a component of a networked computer system (e.g., any one or more of the components shown in FIG. 1, FIG. 2, FIG. 3, FIG. 4A, FIG. 4B, FIG. 5, FIG. 6, FIG. 7, or FIGS. 8A-8D) that includes, is coupled to, or utilizes a machine to execute an operating system to perform operations corresponding to any one or more components shown in FIG. 1, FIG. 2, FIG. 3, FIG. 4A, FIG. 4B, FIG. 5, FIG. 6, FIG. 7, or FIGS. 8A-8D. For example, computer system 900 corresponds to a portion of a computing system when the computing system is executing a portion of any one or more components shown in FIG. 1, FIG. 2, FIG. 3, FIG. 4A, FIG. 4B, FIG. 5, FIG. 6, FIG. 7, or FIGS. 8A-8D.

The machine is connected (e.g., networked) to other machines in a network, such as a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a memory 903 (e.g., flash memory, static random access memory (SRAM), etc.), an input/output system 910, and a data storage system 940, which communicate with each other via a bus 930.

Processing device 902 represents one or more general-purpose processing devices such as a microprocessor, a central processing unit, or the like. In some examples, the processing device is a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 902 includes a special-purpose processing device such as an application specific integrated circuit (ASIC), a field programmable gate array (FPGA), a digital signal processor (DSP), network processor, or the like. The processing device 902 is to execute instructions 912 for performing the operations and steps discussed herein.

In some examples of FIG. 9, agent system 950 represents portions of agent system 780 while the computer system 900 is executing those portions of agent system 780. Instructions 912 include portions of agent system 950 when those portions of the agent system 950 are being executed by processing device 902. Thus, the agent system 950 is shown in dashed lines as part of instructions 912 to illustrate that, at times, portions of the agent system 950 are executed by processing device 902. For example, when at least some portion of the agent system 950 is embodied in instructions to cause processing device 902 to perform the method(s) described herein, some of those instructions are read into processing device 902 (e.g., into an internal cache or other memory) from main memory 904 and/or data storage system 940. In some examples, it is not required that all of the agent system 950 be included in instructions 912 at the same time and portions of the agent system 950 are stored in another component of computer system 900 at other times, e.g., when a portion of the agent system 950 is not being executed by processing device 902.

The computer system 900 further includes a network interface device 908 to communicate over the network 920. Network interface device 908 provides a two-way data communication coupling to a network. In some examples, network interface device 908 includes an integrated-services digital network (ISDN) card, cable modem, satellite modem, or a modem to provide a data communication connection to a corresponding type of telephone line. In some examples, network interface device 908 includes a local area network (LAN) card to provide a data communication connection to a compatible LAN. Wireless links are included, in some examples. Network interface device 908 sends and receives electrical, electromagnetic, or optical signals that carry digital data representing various types of information.

The network link is capable of providing data communication through one or more networks to other data devices. In some examples, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 900.

Computer system 900 is capable of sending messages and receiving data, including program code, through the network(s) and network interface device 908. In some examples, a server is capable of transmitting a requested code for an application program through the Internet and network interface device 908. The received code is executed by processing device 902 as it is received, and/or stored in data storage system 940 or other non-volatile storage for later execution.

The input/output system 910 includes an output device, such as a display, for example a liquid crystal display (LCD) or a touchscreen display, for displaying information to a computer user, or a speaker, a haptic device, or another form of output device. The input/output system 910 includes an input device, for example, alphanumeric keys and other keys configured for communicating information and command selections to processing device 902. An input device sometimes includes a cursor control, such as a mouse, a trackball, or cursor direction keys for communicating direction information and command selections to processing device 902 and for controlling cursor movement on a display. An input device sometimes includes a microphone, a sensor, or an array of sensors, for communicating sensed information to processing device 902. Examples of sensed information include voice commands, audio signals, geographic location information, haptic information, and/or digital imagery, for example.

The data storage system 940 includes a machine-readable storage medium 942 (also known as a computer-readable medium) on which is stored instructions 944 or software embodying any of the methodologies or functions described herein. The instructions 944 sometimes reside, completely or at least partially, within the main memory 904 and/or within the processing device 902 during execution thereof by the computer system 900, the main memory 904 and the processing device 902 also constituting machine-readable storage media. In one example, the instructions 944 include instructions to implement functionality corresponding to an automated agent or agent system (e.g., any one or more of the components shown in any one or more components shown in FIG. 1, FIG. 2, FIG. 3, FIG. 4A, FIG. 4B, FIG. 5, FIG. 6, agent system 780 of FIG. 7, or FIGS. 8A-8D).

Dashed lines are used in FIG. 9 to indicate that it is not required that the agent system be embodied entirely in instructions 912, 914, and 944 at the same time. In one example, portions of the agent system are embodied in instructions 914, which are read into main memory 904 as instructions 914, and portions of instructions 912 are read into processing device 902 as instructions 912 for execution. In another example, some portions of the agent system are embodied in instructions 944 while other portions are embodied in instructions 914 and still other portions are embodied in instructions 912.

While the machine-readable storage medium 942 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 9 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to actions and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations described herein. This apparatus is specially constructed for the intended purposes, in some examples. In other examples, the apparatus includes a general-purpose computer selectively activated or reconfigured by a computer program stored in the computer. In some examples, a computer system or other data processing system including any one or more of the components shown in FIG. 1, FIG. 2, FIG. 3, FIG. 4A, FIG. 4B, FIG. 5, FIG. 6, FIG. 7, FIG. 8A-FIG. 8D and/or FIG. 9, carries out the above-described computer-implemented methods in response to its processor executing a computer program (e.g., a sequence of instructions) contained in a memory or other non-transitory machine-readable storage medium. Such a computer program is be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems are capable of being used. A more specialized apparatus is constructed, in some examples. Examples of structure for these systems are provided in the description. Aspects of this disclosure are not limited to any particular programming language. A variety of programming languages are usable to implement the various aspects of this disclosure.

Some examples of the present disclosure are provided as a computer program product, or software, which includes a machine-readable medium having stored thereon instructions, which is used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in artificial intelligence (AI) features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform. According to the techniques described herein, personal data may be removed from any training dataset that is used to train AI models.

The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Illustrative examples of the technologies disclosed herein are provided below. An example of the technologies includes any of the examples described herein, or any combination of any of the examples described herein, or any combination of any portions of the examples described herein.

In some aspects, the techniques described herein relate to a method including: responsive to digital input received in a natural language, formulating an instruction for a generative machine learning model (GMLM), wherein the instruction includes an input validation sub-instruction and a code generation sub-instruction; via processing of the digital input and the code generation sub-instruction by the GMLM, generating and outputting, by the GMLM, code in a programming language, wherein the code in the programming language corresponds to the digital input received in the natural language; via processing of the input validation sub-instruction and the code by the GMLM, detecting an unvalidated portion of the digital input; and excluding the unvalidated portion of the digital input from an execution of the code generated by the GMLM.

In some aspects, the techniques described herein relate to a method, further including: preventing the execution of the code in response to the detecting of the unvalidated portion of the digital input.

In some aspects, the techniques described herein relate to a method, further including: invoking a tool to execute code generated by the GMLM via the code generation sub-instruction and the validated portion of the digital input.

In some aspects, the techniques described herein relate to a method, further including: receiving output via execution, by the tool, of the code; and via processing of the output of the tool and an output validation sub-instruction by the GMLM, generating and outputting a response to the digital input.

In some aspects, the techniques described herein relate to a method, wherein the output validation sub-instruction includes a threshold condition and the method further includes: responsive to determining that the response does not meet or exceed the threshold condition, causing the GMLM to revise the code generation sub-instruction and generate revised code via processing, by the GMLM, of the digital input and the revised code generation sub-instruction.

In some aspects, the techniques described herein relate to a method, wherein the response to the digital input includes an implicit preference derived by the GMLM from the output of the tool, and the method further includes using the implicit preference to control at least one of an application system or a device.

In some aspects, the techniques described herein relate to a method, wherein at least one of (i) the application system includes an entity matching component that uses the implicit preference to identify digital entities that match criteria or (ii) the device includes an autonomous or semi-autonomous component that uses the implicit preference to determine an action to be performed by the autonomous or semi-autonomous component.

In some aspects, the techniques described herein relate to a method, further including: causing the GMLM to include, in the response to the digital input, reasoning related to the generation of the code by the GMLM, wherein the reasoning includes a portion of the code generation sub-instruction.

In some aspects, the techniques described herein relate to a method, wherein the input validation sub-instruction identifies a plurality of standard clauses to the GMLM and the method further includes: detecting the unvalidated portion of the digital input by, via the GMLM, decomposing the code generated by the GMLM into code clauses and mapping the code clauses to the plurality of standard clauses.

In some aspects, the techniques described herein relate to a method, wherein the standard clauses are arguments of an application programming interface and the standard clauses are listed in the input validation sub-instruction.

In some aspects, the techniques described herein relate to a method, further including: responsive to detecting the unvalidated portion of the digital input, generating and outputting an error message.

In some aspects, the techniques described herein relate to a system including: a processor; and a memory coupled to the processor, wherein the memory includes instructions that when executed by the processor cause the processor to: responsive to digital input received in a natural language, formulate an instruction for a generative machine learning model (GMLM), wherein the instruction includes an input validation sub-instruction and a code generation sub-instruction; via processing of the digital input and the code generation sub-instruction by the GMLM, generate and output, by the GMLM, code in a programming language, wherein the code in the programming language corresponds to the digital input received in the natural language; via processing of the input validation sub-instruction and the code by the GMLM, detect an unvalidated portion of the digital input; and exclude the unvalidated portion of the digital input from an execution of the code generated by the GMLM.

In some aspects, the techniques described herein relate to a system, wherein the instructions further cause the processor to: prevent the execution of the code in response to the detecting of the unvalidated portion of the digital input.

In some aspects, the techniques described herein relate to a system, wherein the instructions further cause the processor to: invoke a tool to execute code generated by the GMLM via the code generation sub-instruction and the validated portion of the digital input; receive output via execution, by the tool, of the code; and via processing of the output of the tool and an output validation sub-instruction by the GMLM, generate and output a response to the digital input.

In some aspects, the techniques described herein relate to a system, wherein the output validation sub-instruction includes a threshold condition and the instructions further cause the processor to: responsive to determining that the response does not meet or exceed the threshold condition, cause the GMLM to revise the code generation sub-instruction and generate revised code via processing, by the GMLM, of the digital input and the revised code generation sub-instruction.

In some aspects, the techniques described herein relate to a system, wherein the response to the digital input includes an implicit preference derived by the GMLM from the output of the tool, and the instructions further cause the processor to use the implicit preference to control at least one of an application system or a device.

In some aspects, the techniques described herein relate to a system, wherein at least one of (i) the application system includes an entity matching component that uses the implicit preference to identify digital entities that match criteria or (ii) the device includes an autonomous or semi-autonomous component that uses the implicit preference to determine an action to be performed by the autonomous or semi-autonomous component.

In some aspects, the techniques described herein relate to a system, wherein the input validation sub-instruction identifies a plurality of standard clauses to the GMLM and the instructions further cause the processor to: detect the unvalidated portion of the digital input by, via the GMLM, decomposing the code generated by the GMLM into code clauses and mapping the code clauses to the plurality of standard clauses.

In some aspects, the techniques described herein relate to a non-transitory computer-readable medium including instructions that when executed by a processor cause the processor to: responsive to digital input received in a natural language, formulate an instruction for a generative machine learning model (GMLM), wherein the instruction includes an input validation sub-instruction and a code generation sub-instruction; via processing of the digital input and the code generation sub-instruction by the GMLM, generate and output, by the GMLM, code in a programming language, wherein the code in the programming language corresponds to the digital input received in the natural language; via processing of the input validation sub-instruction and the code by the GMLM, detect an unvalidated portion of the digital input; and exclude the unvalidated portion of the digital input from an execution of the code generated by the GMLM.

In some aspects, the techniques described herein relate to a non-transitory computer-readable medium, wherein the instructions further cause the processor to: invoke a tool to execute code generated by the GMLM via the code generation sub-instruction and the validated portion of the digital input; receive output via execution, by the tool, of the code; via processing of the output of the tool and an output validation sub-instruction by the GMLM, generate and output a response to the digital input, wherein the response to the digital input includes an implicit preference derived by the GMLM from the output of the tool; and use the implicit preference to control at least one of an application system or a device, wherein at least one of (i) the application system includes an entity matching component that uses the implicit preference to identify digital entities that match criteria or (ii) the device includes an autonomous or semi-autonomous component that uses the implicit preference to determine an action to be performed by the autonomous or semi-autonomous component.

Clause 1. A computer-implemented method comprising: responsive to digital input received in a natural language, formulating an instruction for a generative machine learning model, GMLM, wherein the instruction comprises an input validation sub-instruction and a code generation sub-instruction; via processing of the digital input and the code generation sub-instruction by the GMLM, generating and outputting, by the GMLM, code in a programming language, wherein the code in the programming language corresponds to the digital input received in the natural language; via processing of the input validation sub-instruction and the code by the GMLM, detecting an unvalidated portion of the digital input; and excluding the unvalidated portion of the digital input from an execution of the code generated by the GMLM.

Clause 2. The method of clause 1, further comprising: preventing the execution of the code in response to the detecting of the unvalidated portion of the digital input.

Clause 3. The method of clause 1 or claim 2, further comprising: invoking a tool to execute code generated by the GMLM via the code generation sub-instruction and the validated portion of the digital input.

Clause 4. The method of clause 2, further comprising: receiving output via execution, by the tool, of the code; and via processing of the output of the tool and an output validation sub-instruction by the GMLM, generating and outputting a response to the digital input.

Clause 5. The method of clause 3, wherein the output validation sub-instruction comprises a threshold condition and the method further comprises: responsive to determining that the response does not meet or exceed the threshold condition, causing the GMLM to revise the code generation sub-instruction and generate revised code via processing, by the GMLM, of the digital input and the revised code generation sub-instruction.

Clause 6. The method of clause 3, wherein the response to the digital input comprises an implicit preference derived by the GMLM from the output of the tool, and the method further comprises using the implicit preference to control at least one of an application system or a device.

Clause 7. The method of clause 5, wherein at least one of i) the application system comprises an entity matching component that uses the implicit preference to identify digital entities that match criteria or ii) the device comprises an autonomous or semi-autonomous component that uses the implicit preference to determine an action to be performed by the autonomous or semi-autonomous component.

Clause 8. The method of clause 2, further comprising: causing the GMLM to include, in the response to the digital input, reasoning related to the generation of the code by the GMLM, wherein the reasoning comprises a portion of the code generation sub-instruction.

Clause 9. The method of any preceding clause, wherein the input validation sub-instruction identifies a plurality of standard clauses to the GMLM and the method further comprises: detecting the unvalidated portion of the digital input by, via the GMLM, decomposing the code generated by the GMLM into code clauses and mapping the code clauses to the plurality of standard clauses.

Clause 10. The method of clause 9, wherein the standard clauses are arguments of an application programming interface and the standard clauses are listed in the input validation sub-instruction.

Clause 11. The method of any preceding clause, further comprising: responsive to detecting the unvalidated portion of the digital input, generating and outputting an error message.

Clause 12. An apparatus comprising: a processor; and a memory in communication with the processor, the memory storing instructions that, when executed by the processor, perform functions of: responsive to digital input received in a natural language, formulating an instruction for a generative machine learning model, GMLM, wherein the instruction comprises an input validation sub-instruction and a code generation sub-instruction; via processing of the digital input and the code generation sub-instruction by the GMLM, generating and outputting, by the GMLM, code in a programming language, wherein the code in the programming language corresponds to the digital input received in the natural language; via processing of the input validation sub-instruction and the code by the GMLM, detecting an unvalidated portion of the digital input; and excluding the unvalidated portion of the digital input from an execution of the code generated by the GMLM.

Clause 13. The apparatus of clause 12, wherein the instructions, when executed by the processor, cause the apparatus to: prevent the execution of the code in response to the detecting of the unvalidated portion of the digital input; or invoke a tool to execute code generated by the GMLM via the code generation sub-instruction and the validated portion of the digital input.

Clause 14. The apparatus of clause 12 or claim 13, wherein the code validation sub-instruction is a wrapper around the code generation sub-instruction, and wherein the wrapper forces code generated by the GMLM to only use arguments that are listed in the wrapper and to follow examples which are in the wrapper, wherein the arguments are arguments for an application programming interface of a tool.

Clause 15. The apparatus of clause 13, wherein the instructions, when executed by the processor, cause the apparatus to: receive output via execution, by the tool, of the code; and via processing of the output of the tool and an output validation sub-instruction by the GMLM, generate and output a response to the digital input.

Clause 16. The apparatus of clause 14, wherein the output validation sub-instruction comprises a threshold condition and wherein the instructions, when executed by the processor, cause the apparatus to: responsive to determining that the response does not meet or exceed the threshold condition, cause the GMLM to revise the code generation sub-instruction and generate revised code via processing, by the GMLM, of the digital input and the revised code generation sub-instruction.

Clause 17. The apparatus of clause 14, wherein the response to the digital input comprises an implicit preference derived by the GMLM from the output of the tool, and wherein the instructions, when executed by the processor, cause the apparatus to use the implicit preference to control at least one of an application system or a device.

Clause 18. The apparatus of clause 16, wherein at least one of i) the application system comprises an entity matching component that uses the implicit preference to identify digital entities that match criteria or ii) the device comprises an autonomous or semi-autonomous component that uses the implicit preference to determine an action to be performed by the autonomous or semi-autonomous component.

Clause 19. The apparatus of clause 13, wherein the instructions, when executed by the processor, cause the apparatus to: cause the GMLM to include, in the response to the digital input, reasoning related to the generation of the code by the GMLM, wherein the reasoning comprises a portion of the code generation sub-instruction.

Clause 20. The apparatus of any of clauses 12 to 19, wherein the input validation sub-instruction identifies a plurality of standard clauses to the GMLM and wherein the instructions, when executed by the processor, cause the apparatus to: detect the unvalidated portion of the digital input by, via the GMLM, decomposing the code generated by the GMLM into code clauses and mapping the code clauses to the plurality of standard clauses.

Aspects of the disclosure have been described with reference to specific examples thereof. Various modifications are capable of being made to the described examples without departing from the spirit and scope of the disclosure reflected in the claims. The specification and drawings are illustrative and not restrictive.

What is claimed is:

1. A method comprising:
responsive to digital input received in a natural language, formulating an instruction for a generative machine learning model (GMLM), wherein the instruction comprises an input validation sub-instruction and a code generation sub-instruction;
via processing of the digital input and the code generation sub-instruction by the GMLM, generating and outputting, by the GMLM, code in a programming language, wherein the code in the programming language corresponds to the digital input received in the natural language;
via processing of the input validation sub-instruction and the code by the GMLM, detecting an unvalidated portion of the digital input; and
excluding the unvalidated portion of the digital input from an execution of the code generated by the GMLM.

2. The method of claim 1, further comprising:
preventing the execution of the code in response to the detecting of the unvalidated portion of the digital input.

3. The method of claim 1, further comprising:
invoking a tool to execute code generated by the GMLM via the code generation sub-instruction and the validated portion of the digital input.

4. The method of claim 3, further comprising:
receiving output via execution, by the tool, of the code; and
via processing of the output of the tool and an output validation sub-instruction by the GMLM, generating and outputting a response to the digital input.

5. The method of claim 4, wherein the output validation sub-instruction comprises a threshold condition and the method further comprises:
responsive to determining that the response does not meet or exceed the threshold condition, causing the GMLM to revise the code generation sub-instruction and generate revised code via processing, by the GMLM, of the digital input and the revised code generation sub-instruction.

6. The method of claim 4, wherein the response to the digital input comprises an implicit preference derived by the GMLM from the output of the tool, and the method further comprises using the implicit preference to control at least one of an application system or a device.

7. The method of claim 6, wherein at least one of (i) the application system comprises an entity matching component that uses the implicit preference to identify digital entities that match criteria or (ii) the device comprises an autonomous or semi-autonomous component that uses the implicit preference to determine an action to be performed by the autonomous or semi-autonomous component.

8. The method of claim 2, further comprising:
causing the GMLM to include, in the response to the digital input, reasoning related to the generation of the code by the GMLM, wherein the reasoning comprises a portion of the code generation sub-instruction.

9. The method of claim 1, wherein the input validation sub-instruction identifies a plurality of standard clauses to the GMLM and the method further comprises:
detecting the unvalidated portion of the digital input by, via the GMLM, decomposing the code generated by the GMLM into code clauses and mapping the code clauses to the plurality of standard clauses.

10. The method of claim 9, wherein the standard clauses are arguments of an application programming interface and the standard clauses are listed in the input validation sub-instruction.

11. The method of claim 1, further comprising:
responsive to detecting the unvalidated portion of the digital input, generating and outputting an error message.

12. A system comprising:
a processor; and
a memory coupled to the processor, wherein the memory comprises instructions that when executed by the processor cause the processor to:
responsive to digital input received in a natural language, formulate an instruction for a generative machine learning model (GMLM), wherein the instruction comprises an input validation sub-instruction and a code generation sub-instruction;
via processing of the digital input and the code generation sub-instruction by the GMLM, generate and output, by the GMLM, code in a programming language, wherein the code in the programming language corresponds to the digital input received in the natural language;
via processing of the input validation sub-instruction and the code by the GMLM, detect an unvalidated portion of the digital input; and
exclude the unvalidated portion of the digital input from an execution of the code generated by the GMLM.

13. The system of claim 12, wherein the instructions further cause the processor to:
prevent the execution of the code in response to the detecting of the unvalidated portion of the digital input.

14. The system of claim 12, wherein the instructions further cause the processor to:
invoke a tool to execute code generated by the GMLM via the code generation sub-instruction and the validated portion of the digital input;
receive output via execution, by the tool, of the code; and
via processing of the output of the tool and an output validation sub-instruction by the GMLM, generate and output a response to the digital input.

15. The system of claim 14, wherein the output validation sub-instruction comprises a threshold condition and the instructions further cause the processor to:
responsive to determining that the response does not meet or exceed the threshold condition, cause the GMLM to revise the code generation sub-instruction and generate revised code via processing, by the GMLM, of the digital input and the revised code generation sub-instruction.

16. The system of claim 15, wherein the response to the digital input comprises an implicit preference derived by the GMLM from the output of the tool, and the instructions further cause the processor to use the implicit preference to control at least one of an application system or a device.

17. The system of claim 16, wherein at least one of (i) the application system comprises an entity matching component that uses the implicit preference to identify digital entities that match criteria or (ii) the device comprises an autonomous or semi-autonomous component that uses the implicit preference to determine an action to be performed by the autonomous or semi-autonomous component.

18. The system of claim 12, wherein the input validation sub-instruction identifies a plurality of standard clauses to the GMLM and the instructions further cause the processor to:
detect the unvalidated portion of the digital input by, via the GMLM, decomposing the code generated by the GMLM into code clauses and mapping the code clauses to the plurality of standard clauses.

19. A non-transitory computer-readable medium comprising instructions that when executed by a processor cause the processor to:
responsive to digital input received in a natural language, formulate an instruction for a generative machine learning model (GMLM), wherein the instruction comprises an input validation sub-instruction and a code generation sub-instruction;
via processing of the digital input and the code generation sub-instruction by the GMLM, generate and output, by the GMLM, code in a programming language, wherein the code in the programming language corresponds to the digital input received in the natural language;
via processing of the input validation sub-instruction and the code by the GMLM, detect an unvalidated portion of the digital input; and
exclude the unvalidated portion of the digital input from an execution of the code generated by the GMLM.

20. The non-transitory computer-readable medium of claim 19, wherein the instructions further cause the processor to:
invoke a tool to execute code generated by the GMLM via the code generation sub-instruction and the validated portion of the digital input;
receive output via execution, by the tool, of the code;
via processing of the output of the tool and an output validation sub-instruction by the GMLM, generate and output a response to the digital input, wherein the response to the digital input comprises an implicit preference derived by the GMLM from the output of the tool; and
use the implicit preference to control at least one of an application system or a device, wherein at least one of (i) the application system comprises an entity matching component that uses the implicit preference to identify digital entities that match criteria or (ii) the device comprises an autonomous or semi-autonomous component that uses the implicit preference to determine an action to be performed by the autonomous or semi-autonomous component.
